(19) United States
(12) Patent Application Publication
(10) Pub. No.: US 2019/0197468 A1
(43) Pub. Date: Jun. 27, 2019

(54) INFORMATION PROCESSING SYSTEM, KEY INFORMATION MANAGEMENT DEVICE, KEY INFORMATION MANAGEMENT METHOD AND NON-TRANSITORY STORAGE MEDIUM STORING PROGRAM

(71) Applicant: TOYOTA JIDOSHA KABUSHIKI KAISHA, Toyota-shi (JP)

(72) Inventors: Masato ENDO, Nagakute-shi (JP); Yuichiro HARUNA, Oyama-shi (JP)

(73) Assignee: TOYOTA JIDOSHA KABUSHIKI KAISHA, Toyota-shi (JP)

(21) Appl. No.: 16/225,344

(22) Filed: Dec. 19, 2018

(30) Foreign Application Priority Data
Dec. 21, 2017 (JP) 2017-245061

(51) Int. Cl. G06Q 10/08; G07C 9/00; H04W 4/40

(52) U.S. Cl. CPC G06Q 10/0832; G06Q 10/0835; G07C 2009/00428; H04W 4/40; G07C 9/00309

(57) ABSTRACT

An information processing system includes circuitry configured to: choose, in response to a request from a user terminal carried by a user of a delivery service, a vehicle cabin including a trunk of a rental vehicle scheduled to be rented out, or having been rented out to the user of the delivery service by a car rental service, as a delivery destination of a package, and distribute key information to a delivery company providing the delivery service, the key information being used for unlocking a door accessing the vehicle cabin of the rental vehicle within a rental period of the rental vehicle corresponding to the chosen delivery destination.

### INCORPORATION BY REFERENCE

The disclosure of Japanese Patent Application No. 2017-245061 filed on Dec. 21, 2017 including the specification, drawings and abstract is incorporated herein by reference in its entirety.

### BACKGROUND

### 1. Technical Field

The present disclosure relates to an information processing system, a key information management device, a key information management method and a non-transitory storage medium storing a program.

### 2. Description of Related Art

For example, a mechanism for using a vehicle cabin of a vehicle such as a trunk as a delivery destination of a package is disclosed (see Japanese Unexamined Patent Application Publication No. 2006-206225 (JP 2006-206225 A) or the like).

Specifically, authentication information (key information) for unlocking the vehicle is distributed to a delivery company (for example, a mobile terminal carried by a deliverer). Specifically, when a predetermined transmission signal including the key information is transmitted from the mobile terminal carried by the deliverer to the vehicle and accordingly, authentication based on the key information included in the transmission signal is successful on the vehicle side, a door accessing the trunk of the vehicle (for example, a trunk lid or a back door) is unlocked. Consequently, the deliverer can put the package in the trunk. Accordingly, a delivery company can provide a customer with a delivery service in which a vehicle cabin such as the trunk of the vehicle can be designated as a delivery destination (hereinafter simply referred to as a “vehicle cabin delivery service”).

### SUMMARY

However, those who cannot use vehicles owned by themselves or their close relatives may not be able to use the vehicle cabin delivery service. For example, a user of a vehicle cannot use the vehicle cabin delivery service for delivering a package to the vehicle cabin of the vehicle designated as a delivery destination, when his/her family is out using the vehicle, within a use time period by the family, i.e. within a time period in which the user cannot access the vehicle. For example, a user of a vehicle owned him/herself or his/her close relatives also cannot use the vehicle cabin delivery service for delivering a package to the vehicle cabin of the vehicle designated as a delivery destination, in a case where he/she is traveling or going on a business trip with transportations other than the vehicle, even when he/she wants baggage needed at travel or business trip destination (e.g. a passport or tickets arranged at the site, leisure goods to be rented at the site, etc.) to be delivered. Moreover, for example, those who do not have vehicles owned by themselves or their close relatives may not use the vehicle cabin delivery service in the first place since there is no vehicle that they can access.

The present disclosure provides an information processing system, a key information management device, a key information management method and a non-transitory storage medium storing a program capable of allowing a user who cannot use a vehicle owned by him/herself or his/her close relatives to use a delivery service in which a vehicle cabin of a vehicle can be designated as a delivery destination of a package.

A first aspect of the present disclosure provides an information processing system including circuitry configured to: choose, in response to a request from a user terminal of a delivery service, a vehicle cabin including a trunk of a rental vehicle scheduled to be rented out, or having been rented out to a user of the delivery service by a car rental service, as a delivery destination of a package; and distribute key information to a delivery company providing the delivery service, the key information being used for unlocking a door accessing the vehicle cabin of the rental vehicle within a rental period of the rental vehicle corresponding to the chosen delivery destination.

The information processing system according to the first aspect of the disclosure is able to designate the vehicle cabin of the rental vehicle rented by a car sharing service or a car rental service as the delivery destination of the package, and to allow the delivery company to acquire the key information for unlocking the door accessing the vehicle cabin of the rental vehicle. Therefore, a deliverer of the delivery company can unlock the door of the rental vehicle designated as the delivery destination using the acquired key information to deliver the package to the vehicle cabin of the rental vehicle. That is, the information processing system is able to implement a mechanism of the vehicle cabin delivery service in which the vehicle cabin of the rental vehicle rented by the car sharing service or the like can be designated as the delivery destination of the package. The user is able to receive the vehicle cabin delivery service using the rental vehicle rented by the car sharing service or the like even when a vehicle owned by him/herself or his/her close relatives cannot be accessed. Consequently, the information processing system is capable of allowing the user who cannot use a vehicle owned by him/herself or his/her close relatives to use delivery service in which the vehicle cabin of the vehicle can be designated as the delivery destination of the package.

In the first aspect, the circuitry may be configured to acquire rental reservation information associated with rental reservation of a vehicle by the user from a predetermined external device relating to the car rental service, and to notify the user of the rental vehicle specified by the rental reservation information via the user terminal in a case where the delivery destination of the package is designated by the user terminal.

According to the above configuration, it is possible to notify the user of the reserved rental vehicle on the user terminal by which a delivery request is made without receiving an instruction from the user. Therefore, the user does not need to do extra operations including separate confirmation of information relating to the rental vehicle upon transmitting the delivery request from the user terminal, thereby improving convenience and workability when the delivery request is made. The user also does not need to do extra operations including separate confirmation of whether or not the rental reservation of the rental vehicle is properly completed as a premise of the delivery request, thereby improving convenience and workability when the delivery request is made from this viewpoint. Accordingly, the information processing system is capable of improving convenience and workability upon making the delivery request for the vehicle cabin delivery service in which the vehicle cabin of the rental vehicle rented by the car sharing service can be designated as the delivery destination by the user via the user terminal.

In the above configuration, the circuitry may be configured to display the rental vehicle specified by the rental reservation information on a display device of the user terminal.

The information processing system according to the above configuration is able to, specifically, notify the user of the reserved rental vehicle by display the reserved rental vehicle on the display device (for example, a display of a smartphone, etc.) of the user terminal by which the delivery request is made.

In the above configuration, the circuitry may be configured to choose the vehicle cabin of the rental vehicle as the delivery destination of the package in a case where the rental vehicle displayed on the display device is selected and the vehicle cabin of the rental vehicle is designated as the delivery destination in response to a predetermined manipulation on the user terminal.

The information processing system according to the above configuration is able to choose the vehicle cabin of the reserved rental vehicle as the delivery destination of the package by causing the user to directly select the reserved rental vehicle displayed on the display device of the user terminal by which the delivery request is made.

In the first aspect, the circuitry may be configured to recognize a terminal directly operated by the user or a terminal to which an input content corresponding to the request from the user is input by the delivery company providing the delivery service, as the user terminal of the delivery service.

The information processing system according to the above configuration is able to implement the vehicle cabin delivery service using the rental vehicle rented by the car sharing service or the like based on a request from the terminal directly operated by the user, for example, a smartphone carried by the user. Furthermore, the information processing system is capable of implementing the vehicle cabin delivery service using the rental vehicle rented by the car sharing service or the like based on a request from a delivery request terminal provided at a business office of the delivery company or the like.

In the first aspect, the circuitry may be configured to accept a first reservation to rent a trunk portion of the rental vehicle as an accommodation place to the user in response to a request from a user terminal of the car rental service, and to accept a second reservation from another user of the car rental service to rent the rental vehicle for using the vehicle cabin other than the trunk portion within a rental period corresponding to the first reservation.

The information processing system according to the above configuration is able to separately rent the trunk portion used as the delivery destination in the vehicle cabin delivery service and the vehicle cabin (that is, passenger compartment) other than the trunk portion, which is used as an accommodation place or used for driving the rental vehicle, for the rental vehicle rented by the car sharing service or the like. Therefore, the information processing device is capable of efficiently operating the rental service of the rental vehicle such as the car sharing service.

A second aspect of the present disclosure provides a key information management device including circuitry configured to distribute key information to a delivery company providing a delivery service in a case where a vehicle cabin of a rental vehicle is chosen as a delivery destination of a package in response to a request from a user of the delivery service, the rental vehicle being a vehicle scheduled to be rented out, or having been rented out to the user of the delivery service by a car rental service, the key information being used for unlocking a door accessing the vehicle cabin of the rental vehicle within a rental period of the rental vehicle.

The key information management device according to the second aspect of the disclosure is able to allow the delivery company providing the vehicle cabin delivery service to deliver the package to the vehicle cabin of the reserved rental vehicle rented by the car sharing service or the like. Therefore, the user is able to use the vehicle cabin delivery service using the rental vehicle rented by the car sharing service or the like even when the user cannot use a vehicle owned by him/herself or his/her close relatives. Accordingly, the key information management device is capable of enabling the user who cannot use the vehicle owned by him/herself or his/her close relatives to use the delivery service (vehicle cabin delivery service) in which the vehicle cabin of the vehicle can be designated as the delivery destination of the package.

A third aspect of the present disclosure a key information management method including, distributing key information to a delivery company providing a delivery service in a case where a vehicle cabin of a rental vehicle is chosen as a delivery destination of a package in response to a request from a user, the rental vehicle being a vehicle scheduled to be rented out, or having been rented out to the user of the delivery service by a car rental service, the key information being used for unlocking a door accessing the vehicle cabin of the rental vehicle within a rental period of the rental vehicle.

A fourth aspect of the present disclosure provides a non-transitory storage medium storing a program causing a key information management device to execute the key information management method according to the third aspect when the program is executed by at least one processing device of the key information management device.

According to the aspects of the present disclosure, it is possible to provide an information processing system, a key information management device, a key information management method and a non-transitory storage medium storing a program capable of allowing the user who cannot use the vehicle owned by him/herself or his/her close relatives to use the delivery service in which the vehicle cabin of the vehicle can be designated as the delivery destination of the package.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating an example of an overall configuration of an authentication key management system;

FIG. 2 is a diagram mainly illustrating an example of a configuration regarding locking and unlocking of a vehicle in the authentication key management system;

FIG. 3 is a diagram mainly illustrating an example of a configuration regarding a key sharing service in the authentication key management system;

FIG. 4 is a diagram mainly illustrating an example of a configuration regarding a vehicle cabin delivery service for regular user in the authentication key management system;

FIG. 5 is a diagram mainly illustrating an example of a configuration regarding a consumer to consumer (C2C) car sharing service in the authentication key management system;

FIG. 6 is a diagram mainly illustrating an example of a configuration regarding a business to consumer (B2C) car sharing service in the authentication key management system;

FIG. 7 is a diagram mainly illustrating an example of a configuration regarding a vehicle cabin delivery service for lessee user in the authentication key management system;

FIG. 8A is a sequence diagram illustrating an exemplified operation of the authentication key management system regarding the vehicle cabin delivery service for lessee user;

FIG. 8B is a sequence diagram illustrating an exemplified operation of the authentication key management system regarding the vehicle cabin delivery service for lessee user;

FIG. 8C is a sequence diagram illustrating an exemplified operation of the authentication key management system regarding the vehicle cabin delivery service for lessee user; and

FIG. 8D is a sequence diagram illustrating an exemplified operation of the authentication key management system regarding the vehicle cabin delivery service for lessee user.

### DETAILED DESCRIPTION OF EMBODIMENTS

Hereinafter, modes for carrying out the disclosure will be described with reference to the drawings.

Overall Configuration of Authentication Key Management System

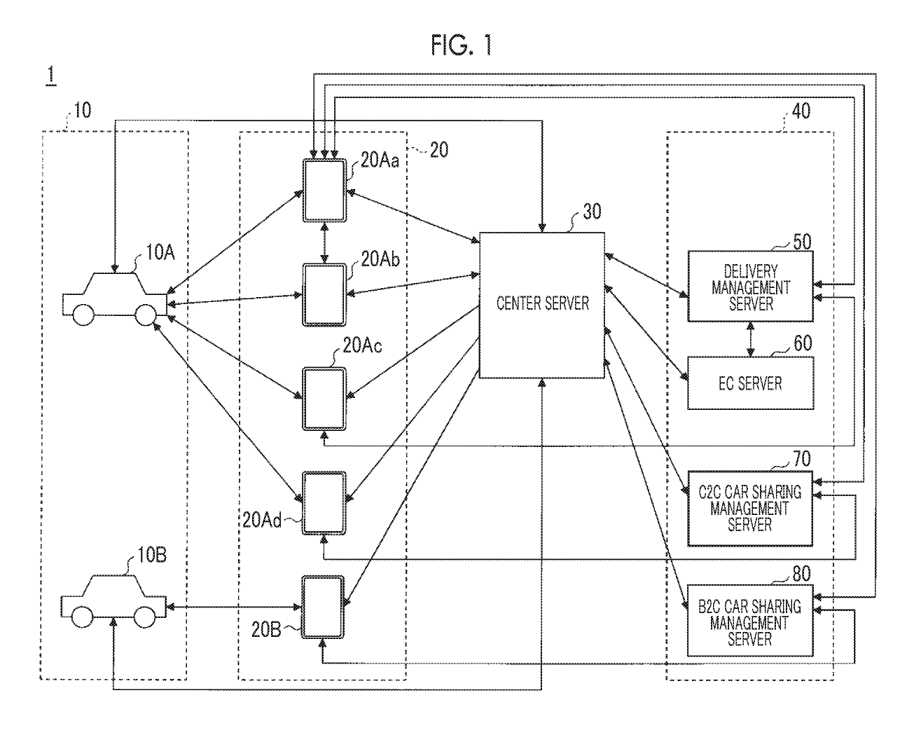

FIG. 1 is a diagram illustrating an example of an overall configuration of an authentication key management system 1 according to an embodiment.

An authentication key management system 1 (an example of the information processing system) includes a vehicle 10, a mobile terminal 20, a center server 30, and a service management server 40.

The vehicle 10 can perform wireless communication (hereinafter simply referred to as a “near field communication”) with the mobile terminal 20 at a relatively short range (a distance that allows communication between the inside of a vehicle cabin and the outside of the vehicle cabin) according to a predetermined communication standard. The vehicle 10 is a target on which locking and unlocking of doors and activation (ignition on) of the vehicle 10 are performed based on transmission signals (an authentication request, a locking request, and an unlocking request to be described below) from the mobile terminal 20. The door of the vehicle 10 may include not only a door for getting on and off, but also a door for a cargo (for example, a trunk lid or a back door) for accessing a trunk (luggage compartment). The ignition on (IG-ON) of the vehicle 10 may include ON of a power supply to an electric motor in the vehicle 10 using the electric motor as a main power source, in addition to startup of an engine in the vehicle 10 using the engine as a main power source. Hereinafter, in the embodiment, description will be given on the premise that the vehicle 10 includes an engine 117 to be described below as a main power source, the activation (IG-ON) of the vehicle 10 corresponds to startup of the engine 117, and stopping (IG-OFF) of the vehicle 10 corresponds to stopping of the engine 117.

The vehicle 10 is communicably connected to the center server 30 over a predetermined communication network (for example, a mobile phone network or an Internet network in which a plurality of base stations is terminations). The vehicle 10 transmits vehicle information such as location information to the center server 30, as described below.

The vehicle 10 includes a vehicle 10A owned by an individual and a vehicle 10B owned by a company providing a business to consumer (hereinafter simply referred to as a “B2C”) car sharing service.

The mobile terminal 20 is communicably connected to the center server 30 over a predetermined communication network (for example, a mobile phone network or an Internet network in which a plurality of base stations is terminations). The mobile terminal 20 can unlock or lock the vehicle 10 by acquiring authentication key information (an example of the key information. The authentication key information is hereinafter referred to as an “authentication key”) distributed from the center server 30 and transmitting the acquired authentication key to the vehicle 10 through relatively short-range wireless communication according to a predetermined manipulation of the user.

The mobile terminal 20 may be, for example, a general-purpose mobile phone, a smartphone, or a tablet terminal. As will be described below, a predetermined application program (hereinafter simply referred to as a “key application”) installed in the built-in processing device 23 is activated, and thereby, the above-described function may be realized. The mobile terminal 20 may be a dedicated mobile terminal specialized for unlocking of the doors of the vehicle 10 and activation of the vehicle 10 by acquiring the authentication key from the center server 30 and using the acquired authentication key. The mobile terminal 20 includes mobile terminals 20Aa to 20Ad corresponding to the vehicle 10A and a mobile terminal 20B corresponding to the vehicle 10B.

The mobile terminal 20Aa is a mobile terminal carried by an owner (hereinafter simply referred to as an “owner user”) among regular users of the vehicle 10A (hereinafter simply referred to as “regular users”). The mobile terminal 20Aa may bidirectionally communicate with the mobile terminal 20Ab through wireless communication at a relatively short range.

The mobile terminal 20Ab is a mobile terminal carried by a regular user other than the owner user of the vehicle 10A (for example, including a family member of the owner user and a close friend of the owner user. The regular user is hereinafter referred to as a “sub-user”).

The sub-user may include a user who does not drive the vehicle 10A or a user who cannot drive (for example, an owner user's child under 18 years of age). This is because, for example, when solely a vehicle cabin delivery service to be described below is used, the regular user does not need to drive the vehicle 10A.

The mobile terminal 20Ac is carried by a deliverer of a company that provides a vehicle cabin delivery service to be described below (hereinafter simply referred to as a “delivery company”). The mobile terminal 20Ac is communicably connected to the center server 30 and a delivery management server 50 to be described below over a predetermined communication network (for example, a mobile phone network or an Internet network in which a plurality of base stations is terminations).

The mobile terminal 20Ad is a mobile terminal carried by a lessee of the vehicle 10A in a consumer to consumer (hereinafter simply referred to as a “C2C”) car sharing service to be described below. The mobile terminal 20Ad is communicably connected to the center server 30 and a C2C car sharing management server 70 to be described below over the predetermined communication network (for example, a mobile phone network or an Internet network in which a plurality of base stations is terminations).

The mobile terminal 20B is a mobile terminal carried by the lessee of the vehicle 10B in a business to consumer (B2C) car sharing service to be described below. The mobile terminal 20B is communicably connected to the center server 30 and a B2C car sharing management server 80 to be described below over the predetermined communication network (for example, a mobile phone network or an Internet network in which a plurality of base stations is terminations).

The center server 30 is communicably connected to the vehicle 10, the mobile terminal 20, and the service management server 40.

The center server 30 manages issuance of an authentication key of the vehicle 10. For example, the center server 30 issues the authentication key according to a predetermined condition and distributes the authentication key to the mobile terminal 20.

The center server 30 acquires location information of the vehicle 10 from the vehicle 10. Accordingly, the center server 30 can figure out the location of the vehicle 10.

The center server 30 operates the car sharing service for sharing the vehicle 10A among a plurality of regular users including the owner user of the vehicle 10A. Specifically, the center server 30 operates a service for sharing the authentication key of the vehicle 10A that each of a plurality of pre-registered regular users including the owner user can acquire in the mobile terminal 20 of the regular user (the mobile terminals 20Aa, 20Ab) (a key sharing service).

The center server 30 performs a registration process (a use registration process) of allowing the regular user of the vehicle 10A to use a service for using the vehicle 10A (a key sharing service, a vehicle cabin delivery service, a C2C car sharing service, or the like). Specifically, the center server 30 registers an authority to distribute the authentication key to the predetermined mobile terminal 20 (hereinafter simply referred to as an “authentication key arrangement authority”) by a key sharing management unit 3207 or a service management server 40 to be described below transmitting an authentication key arrangement request to be described below in order for the regular user of the vehicle 10A to use the service for using the vehicle 10A.

The center server 30 manages a use situation of the vehicle 10A through a plurality of services (that is, a plurality of companies) through a vehicle cabin delivery service, a C2C car sharing service, and the like to be described below.

The service management server 40 operates and manages various services that are provided using the vehicle 10. The service management server 40 includes a delivery management server 50 and an electronic commerce (EC) server 60 corresponding to the vehicle cabin delivery service, a C2C car sharing management server 70 corresponding to the C2C car sharing service, a B2C car sharing management server 80 corresponding to the B2C car sharing service.

The vehicle cabin delivery service may include a delivery service in which a product ordered at an EC site to be described below is a delivery target, and a delivery service in which a product other than the product ordered at the EC site is a delivery target. The vehicle cabin delivery service in which the product other than the product ordered at the EC site is a delivery target may include a service in which the trunk of the vehicle 10A can be designated as the delivery destination, for example, when a client requests a package delivery to the regular user of the vehicle 10A. Furthermore, the vehicle cabin delivery service in which the product other than the product ordered at the EC site is a delivery target may include a service in which, when the regular user of the vehicle 10A wants to send a package to his/her home from a travel or business trip destination, the vehicle 10A parked in a parking lot of his/her home can be designated as the delivery destination. The vehicle cabin delivery service in which the product other than the product ordered at the EC site is the delivery target may include a service in which the regular user of the vehicle 10A can change a delivery destination to the trunk of the vehicle 10A when there is a notification indicating that a package destined for a house is scheduled to be delivered, from the delivery management server 50 to the regular user through an e-mail, a social networking service (SNS) account, or a specific application program activated at mobile terminals 20Aa, 20Ab. Hereinafter, in the embodiment, description will be given while focusing on the vehicle cabin delivery service in which the product ordered at the EC site is the delivery target. An operation of each configuration related to the vehicle cabin delivery service to be described below can be appropriately applied to an operation of each configuration in the vehicle cabin delivery service in which the product other than the product ordered at the EC site is the delivery target.

The delivery management server 50 is communicably connected to the mobile terminal 20Ac and the center server 30 over a predetermined communication network, and performs an operation and management of a distribution system related to the vehicle cabin delivery service from reception of the package to the delivery of the package to the trunk of the vehicle 10A. The vehicle cabin delivery service as an operation management target of the delivery management server 50 includes a service in which the trunk of the vehicle 10A can be designated as the delivery destination of a package addressed to the regular user of the vehicle 10A (for example, a product ordered at the EC site by the regular user for using at home, a package sent by the regular user from a travel or business trip destination to home, a package sent by any client to the regular user of the vehicle 10A, etc.). In this case, the package addressed to the regular user of the vehicle 10A may include a product ordered at the EC site by the regular user for using at home, a package sent by the regular user from a travel or business trip destination to home, a package sent by any client to the regular user of the vehicle 10A, and the like. Furthermore, the vehicle cabin delivery service as an operation management target of the delivery management server 50 includes a service in which the trunk of the vehicle 10A or the vehicle 10B can be designated as the delivery destination of a package addressed to a lessee who rents the vehicle 10A or the vehicle 10B via the C2C car sharing management server 70 or the B2C car sharing management server 80. Hereinafter, the vehicle cabin delivery service in which the product ordered at the EC site is a delivery target is referred to as a “vehicle cabin delivery service for regular user” for convenience, and the vehicle cabin delivery service in which the product other than the product ordered at the EC site is a delivery target is referred to as a “vehicle cabin delivery service for lessee user” for convenience.

A delivery company operating the delivery management server 50 may provide the regular user of the vehicle 10A with a delivery service in which a vehicle cabin other than the trunk of the vehicle 10A can be designated as a delivery destination in place of the trunk of the vehicle 10A or in addition to the trunk of the vehicle 10A. Hereinafter A delivery service in which the vehicle cabin (that is, the inside of the vehicle 10A) including the trunk of the vehicle 10A can be designated as the delivery destination is referred to as a “vehicle cabin delivery service”. The delivery company operating the delivery management server 50 may provide the regular user of the vehicle 10A with a pick-up service in which the vehicle cabin including the trunk can be designated as a package pick-up point (hereinafter simply referred to as a “vehicle cabin pick-up service”), as well as the vehicle cabin delivery service. That is, the delivery management server 50 may perform an operation and management of the vehicle cabin pick-up service in place of the vehicle cabin delivery service or in addition to the vehicle cabin delivery service. In this case, the package that is a package pick-up target may be a product (that is, a product purchased at the EC site) returning to an operating company of the EC site corresponding to the EC server 60 (or a store opened at the EC site) or may be a package for delivery not related to the EC site. The vehicle cabin pick-up service may be realized as a pick-up service when a company (for example, a laundry company) that provides a service in a form of temporarily keeping products from a customer keeps a package from the regular user of the vehicle 10A. In this case, a laundry company or the like may provide a pick-up management server that operates and manages the vehicle cabin pick-up service, which can be included in the service management server 40, as in the delivery management server 50. That is, the pick-up management server may be provided, in place of the delivery management server 50 or in addition to the delivery management server 50. A recovery service in which the vehicle cabin of the vehicle 10A can be designated as a recovery point of articles that are recovery targets (hereinafter simply referred to as a “vehicle cabin recovery service”) may be provided to the regular user of the vehicle 10A by a company that provides a service in a form of recovering predetermined articles (articles such as waste or goods desired to be purchased, e.g. second-hand book) from customers (for example, a waste collection company or an antique purchase company). In this case, a recovery management server that operates and manages the vehicle cabin recovery service, which may be included in the service management server 40, may be provided by a waste recovery company or the like, similar to the delivery management server 50. That is, the recovery management server may be provided, in place of the delivery management server 50 or in addition to the delivery management server 50.

The EC server 60 is communicably connected to the center server 30 and the delivery management server 50 over a predetermined communication network, and operates a predetermined website (an EC site) for selling products or services. For example, the EC server 60 displays the trunk of the vehicle 10A as an optional delivery destination on a webpage for inputting information on the order of the product of the EC site (hereinafter simply referred to as an “order input page”), which is accessed via a browser activated in a user terminal (for example, the mobile terminals 20Aa, 20Ab, etc.; hereinafter simply referred to as a “user terminal”) directly operated by the user, for the regular user of the vehicle 10A and the predetermined delivery company, which are registered in advance (in the embodiment, the delivery company corresponding to the delivery management server 50). Consequently, the regular user of the vehicle 10A can request the delivery company to deliver the purchased product to the trunk of the vehicle 10A, for example, which is parked in a parking lot near his/her home or parked in a parking area of the office for traveling to work even when he/she is not at home. Moreover, for example, the EC server 60 displays the rental vehicle 10 as an optional delivery destination on the order input page of the product of the EC site, which is accessed via a browser activated in a user terminal (for example, the mobile terminal 20Ad, etc.), for the lessee of the rental vehicle 10 (the vehicle 10A or the vehicle 10B) rented by the C2C car sharing service or the B2C car sharing service and the predetermined delivery company which is registered in advance. Consequently, the lessee of the rental vehicle 10A by the C2C car sharing service or the B2C car sharing service also can request the delivery company to deliver the purchased product to the trunk of the vehicle 10A, which is parked in a parking lot near his/her home or parked in a parking area of the office for traveling to work even when he/she is not at home.

The C2C car sharing management server 70 is communicably connected to the mobile terminal 20Ad and the center server 30, and performs an operation and management of the C2C car sharing service that assists in car rental (car sharing) of the vehicle 10A between individuals. Rental options of the vehicle 10A in the C2C car sharing service may include regular rental option in which the vehicle 10A is rented as a transportation, and other rental option in which the vehicle 10A is rented with the whole or a part (such as a trunk) of the vehicle cabin (that is, the former is the whole vehicle cabin including a trunk portion and a passenger compartment, and the latter is the trunk portion or the passenger compartment) as an accommodation place. Hereinafter, the regular rental option in which the vehicle 10A is rented as a transportation is referred to as a “regular rental option” for convenience, and the other rental option in which the vehicle is rented with the whole or a part (such as a trunk) of the vehicle cabin as the accommodation place is referred to as a “trunk sharing rental option” for convenience. For example, the C2C car sharing management server 70 performs an operation and management of the C2C car sharing service such as reception of registration of rental option in addition to date and time when the vehicle 10A can be rented by the owner user, reception of reservation of use from a person (lessee) who wants to rent the vehicle 10A, and arrangement of the authentication key of the vehicle 10A.

The B2C car sharing management server 80 is communicably connected to the mobile terminal 20B and the center server 30, and performs an operation and management of the B2C car sharing service in which the vehicle 10B owned by a predetermined company (for example, a provider of the B2C car sharing service) is rented in an aspect in which the vehicle 10B can be shared (by car sharing) among a plurality of general consumers. Rental options of the vehicle 10B in the B2C car sharing service may also include the trunk sharing rental option as well as the regular rental option, as in a case of the C2C car sharing service as described above. For example, the B2C car sharing management server 80 performs an operation and management of the B2C car sharing service such as reception of reservation of use of the vehicle 10B, and arrangement of a parking location of the vehicle 10B and the authentication key of the vehicle 10B.

A company car use management server that operates a car sharing service (a company car use management service) in which an employee of a company is a lessee, with the vehicle 10 as a company car of the company being a reservation of use target, may be included in the service management server 40, instead of the B2C car sharing management server 80 or in addition to the B2C car sharing management server 80. In this case, when there is an idle time period of the vehicle 10, which is the company car, the

C2C car sharing management server 70 may operate the C2C car sharing service, with the vehicle 10 as a company car being a rental target. The delivery management server 50 and the EC server 60 may operate the vehicle cabin delivery service in which a delivery destination of a package to be delivered to a company can be designated as a trunk of the vehicle 10 that is a company car of the company. Moreover, the B2C car sharing management server 80 may be replaced with a rental car management server for performing a car rental service by which the vehicle 10B is rented.

Details of Configuration Regarding Locking, Unlocking, and Activation of Vehicle

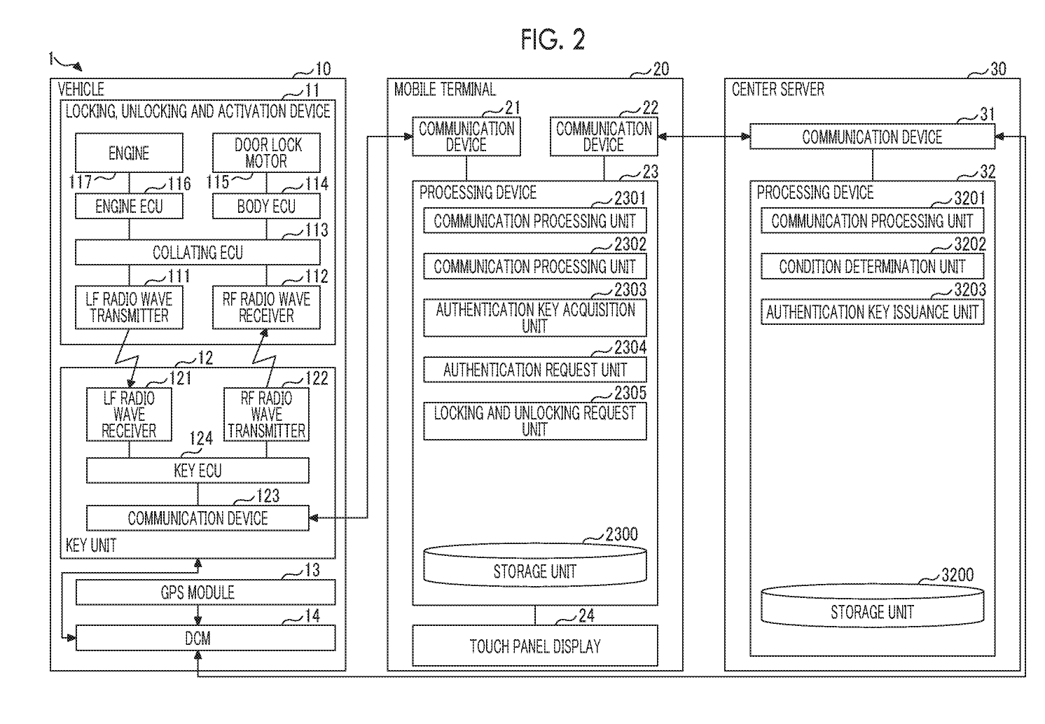

A configuration regarding locking, unlocking, and activation of vehicle 10 in the authentication key management system 1 will be described with reference to FIG. 2.

FIG. 2 is a diagram mainly illustrating an example of the configuration regarding locking, unlocking, and activation of the vehicle 10 in the authentication key management system 1. The vehicle 10 includes a locking, unlocking and activation device 11, a key unit 12, a global positioning system (GPS) module 13, and a data communication module (DCM) 14.

The locking, unlocking and activation device 11 is attached to the vehicle 10 and performs unlocking and locking of the doors of the vehicle 10 according to a locking signal and an unlocking signal to be transmitted as radio waves in a radio frequency (RF) band (for example, 300 MHz to 3 GHz) (hereinafter simply referred to as “RF radio waves”) from the key unit 12. The locking, unlocking and activation device 11 activates the vehicle 10 according to exchange using radio waves in a low frequency (LF) band (for example, 30 Hz to 300 kHz) (hereinafter simply referred to as “LF radio waves”) and RF radio waves with the key unit using a pressing manipulation of an activation switch (not illustrated) provided in the vehicle cabin of the vehicle 10 as a trigger. The locking, unlocking and activation device 11 includes an LF radio wave transmitter 111, an RF radio wave receiver 112, a collating electronic control unit (ECU) 113, a body ECU 114, a door lock motor 115, an engine ECU 116, and an engine 117 as a driving power source of the vehicle 10.

The locking, unlocking and activation device 11 operates with power supplied from an auxiliary battery (not illustrated) mounted on the vehicle 10.

The LF radio wave transmitter 111 is embedded into, for example, a center console or a door handle in the vehicle cabin, and transmits LF radio waves under the control of the collating ECU 113.

The RF radio wave receiver 112 is provided, for example, in a trim of a luggage compartment of the vehicle 10 and receives RF radio waves under the control of the collating ECU 113.

The collating ECU 113 is an electronic control unit that controls locking and unlocking of the doors of the vehicle 10 and activation of the vehicle 10 based on exchange of signals with the key unit 12. The collating ECU 113 is realized by any hardware, any software, or a combination of any hardware and any software. For example, the collating ECU 113 is configured mainly of a microcomputer includes a central processing unit (CPU), a random access memory (RAM), a read only memory (ROM), an auxiliary storage device, a real time clock (RTC), and a communication interface. The collating ECU 113 realizes various control processes by executing various programs stored in the ROM or the auxiliary storage device on the CPU. Hereinafter, the same applies to the key ECU 124 to be described below.

The collating ECU 113 receives an unlocking signal and a locking signal transmitted as RF radio waves from the key unit 12 using the RF radio wave receiver 112.

When the collating ECU 113 receives the unlocking signal or the locking signal, the collating ECU 113 performs authentication of a transmission source (the key unit 12) of the unlocking signal or the locking signal based on key information included in the unlocking signal or the locking signal (hereinafter simply referred to as “internal key information”). For example, when the internal key information registered in an internal memory such as an auxiliary storage device in advance matches the internal key information included in the unlocking signal or the locking signal, the collating ECU 113 determines that the authentication is successful, and when the internal key information registered in the internal memory such as the auxiliary storage device in advance does not match the internal key information included in the unlocking signal or the locking signal, the collating ECU 113 determines that the authentication fails.

For example, the collating ECU 113 may transmit LF radio waves including a “challenge” created in a predetermined method using the internal key information of the internal memory from the LF radio wave transmitter 111 to the key unit 12 and perform challenge response authentication based on a “response” replied from the key unit 12, which is received from the RF radio wave receiver 112.

When the authentication is successful, the collating ECU 113 transmits an unlocking command (upon reception of the unlocking signal) or a locking command (upon reception of the locking signal) to the body ECU 114 via an in-vehicle network such as a controller area network (CAN).

Moreover, the collating ECU 113 transmits a notification that the door is unlocked or locked (an unlocking notification or a locking notification) to the key unit 12 via the LF radio wave transmitter 111 when a reply indicating that the door is normally unlocked or locked (an unlocking reply or a locking reply) is received from the body ECU 114 via the in-vehicle network such as the CAN after the collating ECU 113 transmits the unlocking command or and locking command to the body ECU 114.

As will be described below, in the unlocking signal, solely some of the doors of the vehicle 10 may be designated as unlocked targets. In this case, the collating ECU 113 designates the door as an unlocked target in the unlocking command. Accordingly, the body ECU 114 can operate solely the door lock motor 115 corresponding to some designated doors and unlock solely some doors.

When the above-described activation switch is pressed, the collating ECU 113 performs authentication of the key unit 12 by exchanging signals with the key unit 12 using the LF radio wave transmitter 111 and the RF radio wave receiver 112.

For example, the collating ECU 113 transmits a request signal in an LF band from the LF radio wave transmitter 111 to the key unit 12 to request reply of the internal key information. When a response signal including the internal key information is received from the key unit 12 by the RF radio wave receiver 112, the collating ECU 113 determines authentication success or authentication failure based on matching between the internal key information registered in the internal memory in advance and the internal key information included in the response signal, as in a case of locking and unlocking the doors.

For example, the collating ECU 113 may perform challenge response authentication, as in a case of locking and unlocking of doors.

When the authentication has succeeded, the collating ECU 113 transmits a startup command of the engine 117 to the engine ECU 116 through the in-vehicle network such as the CAN.

The body ECU 114 is an electronic control unit that performs operation control of the door lock motor 115 that is communicably connected via a one-to-one communication line or the like. The body ECU 114 outputs a control command to cause the door lock motor 115 to perform an unlocking operation according to the unlocking command from the collating ECU 113. The body ECU 114 outputs a control command to cause the door lock motor 115 to perform a locking operation according to the locking command from the collating ECU 113. Furthermore, the body ECU 114 transmits the unlocking reply or the locking reply to the collating ECU 113 via the in-vehicle network such as the CAN when the door is normally unlocked or locked by outputting the control command to the door lock motor 115.

The door lock motor 115 is a known electric actuator that unlocks and locks the doors of the vehicle 10 according to the control command from the body ECU 114.

The engine ECU 116 is an electronic control unit that drives and controls the engine 117. Specifically, the engine ECU 116 drives and controls various actuators such as a starter or an injector, which are mounted on the engine 117. When the startup command is input from the collating ECU 113, the engine ECU 116 outputs a control command to various actuators such as a starter or an injector of the engine 117 to start up the engine 117.

The key unit 12 is disposed in the vehicle cabin of the vehicle 10 and transmits the unlocking signal and the locking signal as RF radio waves to the locking, unlocking and activation device 11 according to the unlocking request and the locking request transmitted from the mobile terminal 20. The key unit 12 performs exchange of signals with the locking, unlocking and activation device 11 according to the signal in the LF band transmitted from the locking, unlocking and activation device 11 when the activation switch provided in the vehicle cabin of the vehicle 10 is pressed. The key unit 12 includes an LF radio wave receiver 121, an RF radio wave transmitter 122, a communication device 123, and a key ECU 124.

The key unit 12 may be disposed at a location (for example, a glove box, or the inside of a center console box) at which it is difficult for users seated on respective seats of the vehicle 10 to visually recognize the key unit 12. The key unit 12 may be fixed or may not be fixed to the vehicle 10. The key unit 12 may be operated by a built-in button battery or the like or may be operated by power supplied from an auxiliary battery mounted on the vehicle 10.

The LF radio wave receiver 121 receives the LF radio waves under the control of the key ECU 124.

The RF radio wave transmitter 122 transmits RF radio waves under the control of the key ECU 124.

The communication device 123 is any device that performs near field communication with the mobile terminal 20 under the control of the key ECU 124. The communication device 123 may be, for example, a BLE communication module that performs communication with the mobile terminal 20 in compliance with a Bluetooth (registered trademark) low energy (BLE) communication standard. Hereinafter, description will be given on the premise that a communication standard adopted in the communication device 123 conforms to BLE communication.

The communication device 123 may be a communication device conforming to a short-range communication standard having a very short communicable distance, such as a near field communication (NFC) standard. In this case, the communication device 123 may be built, for example, at a location (for example, the inside of the door handle) close to a body surface of the vehicle 10 outside the vehicle cabin. Accordingly, the key unit 12 (the key ECU 124) can communicate with the mobile terminal 20 outside the vehicle cabin even when the communicable distance of the communication device 123 is very short.

The key ECU 124 is an electronic control unit that performs a control process of transmitting a locking signal and an unlocking signal to the locking, unlocking and activation device 11 according to the unlocking request and the locking request received from the mobile terminal 20.

The key ECU 124 controls the communication device 123 and establishes a state in which communication according to a predetermined communication standard with the mobile terminal 20, such as a BLE communication standard is possible.

Specifically, the key ECU 124 periodically (for example, every several seconds) transmits an advertising packet including advertisement information reachable in a predetermined communication range (for example, several meters to tens of meters) from the communication device 123. The advertisement information includes a universally unique identifier (UUID) corresponding to the key unit 12, a device identifier (ID), and the like. Accordingly, the mobile terminal 20 can identify the key unit 12 mounted on the vehicle 10 that is a target by receiving the advertising packet and confirming the advertisement information.

When a connection request for requesting connection based on the BLE communication is received from the mobile terminal 20 present in a communication range of the vehicle 10 (the key unit 12) that has received the advertising packet, the key ECU 124 establishes a state in which BLE communication between the mobile terminal 20 and the vehicle 10 (the key unit 12) is possible. In this case, the key ECU 124 transmits a connection response indicating that the state in which the BLE communication is possible has been established, to the mobile terminal 20 via the communication device 123.

The key ECU 124 receives an authentication request including an authentication key associated with the key unit 12 from the mobile terminal 20 via the communication device 123 in a state in which the above-described BLE communication is established.

When the authentication request including the authentication key associated with the key unit 12 is received from the mobile terminal 20, the key ECU 124 performs authentication of the mobile terminal 20 based on the authentication key. When the authentication has been successful, the key ECU 124 restores the internal key information stored in an internal memory such as an auxiliary storage device to a usable state. The internal key information is stored in a state that the internal key information cannot be used for authentication in the locking, unlocking and activation device 11, for example, due to a state in which the internal key information is not accessible or a state in which the internal key information has been encrypted. Therefore, when the authentication of the mobile terminal 20 has been successful, the key ECU 124, for example, performs changing of an authority to access the internal memory for changing the key information to an accessible state, or decodes encrypted internal key information based on the authentication key. Accordingly, the key ECU 124 can access the internal key information which is not normally accessible to transmit an unlocking signal or a locking signal including the internal key information to the locking, unlocking and activation device 11 or transmit an unlocking signal or a locking signal including decoded internal key information to the locking, unlocking and activation device 11. Therefore, the locking, unlocking and activation device 11 can perform appropriate authentication based on the internal key information included in the unlocking signal and the locking signal. Even when a situation in which a malicious third party illegally obtains the key unit 12 occurs, the internal key information in the key unit 12, for example, is not accessible or is encrypted, occurrence of theft of the vehicle 10 can be suppressed.

The key ECU 124 receives the unlocking request and the locking request from the mobile terminal 20 via the communication device 123 in a state in which the above-described BLE communication is established. When the authentication of the mobile terminal 20 is successful (specifically, a state in which the BLE communication has been established is kept after the authentication of the mobile terminal 20 has been successful) and the key ECU 124 has received the unlocking request or the locking request from the mobile terminal 20, the key ECU 124 transmits the unlocking signal or the locking signal including locking and unlocking key information to the locking, unlocking and activation device 11 via the RF radio wave transmitter 122.

Accordingly, unlocking or locking of the doors of the vehicle 10 is realized after an authentication process in the locking, unlocking and activation device 11.

Furthermore, the key ECU 124 transmits to an unlocking completion notification to the mobile terminal 20 in which the BLE communication is established, i.e. the mobile terminal 20 which is the transmission source of the unlocking request, via the communication device 123 in a case of receiving the unlocking notification from the locking, unlocking and activation device 11 via the LF radio wave receiver 121 after transmitting the unlocking signal to the locking, unlocking and activation device 11. Similarly, the key ECU 124 transmits to a locking completion notification to the mobile terminal 20 in which the BLE communication is established via the communication device 123 in a case of receiving the locking notification from the locking, unlocking and activation device 11 via the LF radio wave receiver 121 after transmitting the locking signal to the locking, unlocking and activation device 11. Accordingly, the mobile terminal 20, which is the transmission source of the locking request or the unlocking request based on the predetermined manipulation of the user, can figure out that the locking or unlocking of the vehicle 10A has been normally completed.

As described above, the key ECU 124 performs exchange of signals with the locking, unlocking and activation device 11 according to a signal in the LF band transmitted from the locking, unlocking and activation device 11 when the activation switch provided in the vehicle cabin of the vehicle 10 is pressed.

For example, when the request signal is received from the locking, unlocking and activation device 11 by the LF radio wave receiver 121, the key ECU 124 transmits a response signal including the internal key information stored in the internal memory or the like to the locking, unlocking and activation device 11 via the RF radio wave transmitter 122.

For example, when the LF radio waves including the “challenge” are received from the locking, unlocking and activation device 11 by the LF radio wave receiver 121, the key ECU 124 generates a “response” based on the internal key information and transmits the response to the locking, unlocking and activation device 11 via the RF radio wave transmitter 122.

Accordingly, after the authentication process in the locking, unlocking and activation device 11, the startup of the engine 117 is realized.

An authority regarding a function of locking, unlocking, or activating the vehicle 10 imparted by the center server 30 may be defined in the authentication key.

For example, when the authentication key has solely the authority to unlock some of the doors of the vehicle 10, the key ECU 124 transmits an unlocking signal including information for designating the door to be unlocked to the key unit 12 via the RF radio wave transmitter 122. Accordingly, solely some of the doors of the vehicle 10 can be unlocked as described above.

For example, when the authentication key does not have the authority to activate the engine 117, the key ECU 124 may not perform exchange with the locking, unlocking and activation device 11 even when the signal in the LF band from the locking, unlocking and activation device 11 based on a pressing manipulation of the activation switch is received by the LF radio wave receiver 121. Accordingly, it is possible to prohibit the activation of the engine 117 according to the authority of the authentication key.

The GPS module 13 receives GPS signals transmitted from three or more satellites and, desirably, four or more satellites over the vehicle 10, and measures a location of the vehicle 10. The GPS module 13 is communicably connected to the DCM 14 or the like via a one-to-one communication line or an in-vehicle network such as a CAN, and the measured location information of the vehicle 10 is input to the DCM 14 or the like.

The DCM 14 is a communication device that bidirectionally communicates with the center server 30 over a predetermined communication network. The DCM 14 transmits current location information of the vehicle 10 input from the GPS module 13 to the center server 30 at a predefined timing or according to a request from the center server 30, or the like. The DCM 14 transmits, to the center server 30, various types of vehicle information (for example, information indicating that unlocking of the door of the vehicle 10 or activation of the vehicle 10 is performed based on the authentication key, which is acquired from the key unit 12) that can be acquired over an in-vehicle network such as a CAN at a predefined timing or according to a request from the center server 30 or the like.

The mobile terminal 20 includes a communication device 21, a communication device 22, a processing device 23, and a touch panel display (hereinafter simply referred to as a “display”) 24.

The communication device 21 is any device that performs near field communication with the mobile terminal 20 according to the same communication standard as that of the communication device 123. As described above, in a case of the embodiment, the communication device 21 is, for example, a BLE communication module.

The communication device 22 is any device that communicates with the center server 30, the service management server 40, or the like over a predetermined communication network. The communication device 22 is a mobile communication module corresponding to a communication standard such as Long Term Evolution (LTE), 4th Generation (4G), or 5th Generation (5G).

The processing device 23 performs various control processes in the mobile terminal 20. The functions of the processing device 23 may be realized by any hardware, any software, or a combination of any hardware and any software, and includes for example, a CPU, a RAM, a ROM, an auxiliary storage device, an RTC, and various interfaces for communication. The processing device 23 includes, for example, a communication processing unit 2301, a communication processing unit 2302, an authentication key acquisition unit 2303, an authentication request unit 2304, and a locking and unlocking request unit 2305 as functional units that are realized by executing one or more programs stored in the ROM or the auxiliary storage device on the CPU. The processing device 23 includes, for example, a storage unit 2300 that is realized as a storage area in the auxiliary storage device, and a process of storing various pieces of data in the storage unit 2300 is realized by a predetermined program stored in the ROM or the auxiliary storage device.

The communication processing unit 2301 performs bidirectional near field communication with the key unit 12 using the communication device 21 and performs transmission and reception of various signals.

The communication processing unit 2302 connects to the predetermined communication network using the communication device 22 and transmits and receives various signals such as a data signal or a control signal to and from the center server 30, the service management server 40, and the like.

The authentication key acquisition unit 2303 acquires the authentication key from the center server 30, for example, according to a predetermined manipulation of the user with respect to a predetermined graphical user interface (GUI) displayed on the display 24, and stores the acquired authentication key in the storage unit 2300. Hereinafter, the description will be given on the premise that various manipulations with respect to the mobile terminal 20 are performed by a manipulation with respect to the GUI displayed on the display 24 in conjunction with the operation of the key application.

For example, the authentication key acquisition unit 2303 of the mobile terminal 20Aa transmits an authentication key acquisition request to the center server 30 via the communication processing unit 2302. Accordingly, the center server 30 receives the authentication key acquisition request, and issues the authentication key when the center server 30 determines that the authentication key acquisition request is a regular authentication key acquisition request. The authentication key acquisition unit 2303 acquires the authentication key distributed from the center server 30 via the communication processing unit 2302.

For example, the authentication key acquisition unit 2303 of the mobile terminal 20Ab acquires the authentication key distributed from the center server 30 to the mobile terminal 20Ab via the communication processing unit 2302 according to a key sharing request (to be described below) transmitted from the mobile terminal 20Aa to the center server 30.

The authentication key acquisition unit 2303 of the mobile terminal 20Ab may transmit the authentication key acquisition request by itself to the center server 30 via the communication processing unit 2302. In this case, when the center server 30 receives the authentication key acquisition request from the mobile terminal 20Ab, the center server 30 may perform an inquiry about whether or not to permit distribution of the authentication key to the mobile terminal 20Aa of the owner user.

For example, the authentication key acquisition unit 2303 of each of the mobile terminals 20Ac, 20Ad, 20B transmits an authentication key acquisition request to the delivery management server 50, the C2C car sharing management server 70, and the B2C car sharing management server 80 to request acquisition of the authentication key. Accordingly, the delivery management server 50, the C2C car sharing management server 70, and the B2C car sharing management server 80 transmit an authentication key arrangement request to the center server 30 according to reception of the authentication key acquisition request, and the center server 30 issues the authentication key according to reception of the authentication key arrangement request. The authentication key acquisition unit 2303 acquires the authentication key distributed from the center server 30 via the communication processing unit 2302.

The authentication key acquisition unit 2303 of the mobile terminals 20Ac, 20Ad, and 20B may transmit the authentication key acquisition request to the center server 30 via the communication processing unit 2302. In this case, the center server 30 may perform an inquiry of the delivery management server 50, the C2C car sharing management server 70, and the B2C car sharing management server 80 to determine whether or not the authentication key acquisition request is a regular authentication key acquisition request.

The authentication request unit 2304 transmits an authentication request to the key unit 12 of the vehicle 10 via the communication processing unit 2301 to request authentication of the mobile terminal 20 serving as a remote manipulation unit for locking and unlocking the doors of the vehicle 10. For example, when the authentication request unit 2304 finds a key unit corresponding to the authentication key, and specifically, when an advertising packet corresponding to the key unit 12 is received by the communication processing unit 2301, the authentication request unit 2304 may transmit the authentication request to the key unit 12. For example, the authentication request unit 2304 may transmit the authentication request to the key unit 12 according to a predetermined manipulation by the user.

The locking and unlocking request unit 2305 transmits an unlocking request including an authentication key or a locking request including the authentication key to the key unit 12 via the communication processing unit 2301 according to the predetermined manipulation by the user. Accordingly, even when the unlocking request or the locking request has been transmitted to the key unit 12 before the authentication request is transmitted by the authentication request unit 2304, locking and unlocking of the door of the vehicle 10 based on the authentication process in the key unit 12 can be realized. For example, an unlocking button for requesting unlocking of the vehicle 10 and a locking button for requesting locking of the vehicle 10 may be drawn in a GUI serving as a manipulation screen of the display 24, a locking request may be transmitted when the locking button is touched, and an unlocking request may be transmitted when the unlocking button is touched. The locking request and the unlocking request may be transmitted by a manipulation with respect to a predetermined manipulation unit by hardware provided in the mobile terminal 20.

For example, the functions of the authentication key acquisition unit 2303, the authentication request unit 2304, and the locking and unlocking request unit 2305 may be available to the user by a predetermined application program installed in the ROM of the processing device 23, the auxiliary storage device, or the like being activated. Hereinafter, the description will be given on the premise that the functions of the authentication key acquisition unit 2303, the authentication request unit 2304, and the locking and unlocking request unit 2305 of the processing device 23 are available to the user by the key application already installed in the processing device 23 (the auxiliary storage device or the ROM) being activated.

The display 24 is, for example, a liquid crystal display or an organic electroluminescence (EL) display, and is a display device which is provided on a front surface of the mobile terminal 20 and also serving as a known touch panel type manipulation unit.

The center server 30 includes a communication device 31 and a processing device 32.

The functions of the center server 30 may be shared and realized by a plurality of servers. Hereinafter, the same applies to the delivery management server 50, the EC server 60, the C2C car sharing management server 70, and the B2C car sharing management server 80.

The communication device 31 is any device that performs bidirectional communication with each of the vehicle 10, the mobile terminal 20, and the service management server 40 over a predetermined communication network.

The processing device 32 performs various control processes in the center server 30. The functions of the processing device 32 may be realized by any hardware, any software, or a combination of any hardware and any software, and the processing device 32 is mainly configured of one or a plurality of server computers including, for example, a CPU, a RAM, a ROM, an auxiliary storage device, an RTC, and a predetermined communication interface. Hereinafter, the same applies to processing devices 52, 62, 72, 82 to be described below of the delivery management server 50, the EC server 60, the C2C car sharing management server 70, and the B2C car sharing management server 80. The processing device 32 includes, for example, a communication processing unit 3201, a condition determination unit 3202, and an authentication key issuance unit 3203 as functional units that are realized by executing one or more programs stored in the ROM or the auxiliary storage device on the CPU. The processing device 32 includes, for example, a storage unit 3200 that is realized as a storage area defined in an auxiliary storage device of a server computer or an external storage device connected to the server computer, and a process in which various pieces of data are stored in the storage unit 3200 is realized by a program stored in the ROM or the auxiliary storage device. Hereinafter, the same applies to the storage units 520, 620, 720, and 820 to be described below.

The communication processing unit 3201 controls the communication device 31 to perform exchange of various signals such as control signals and information signals with the vehicle 10, the mobile terminal 20, and the service management server 40.

The condition determination unit 3202 determines whether or not the authentication key acquisition request or the authentication key arrangement request is a regular authentication key acquisition request or a regular authentication key arrangement request according to reception of an authentication key acquisition request from the mobile terminal 20 or an authentication key arrangement request from the service management server 40 received by the communication processing unit 3201.

When the condition determination unit 3202 determines that the authentication key acquisition request or the authentication key arrangement request is the regular one, the authentication key issuance unit 3203 specifies a specification of the authentication key to be issued and issues an authentication key corresponding to the specified specification. For example, the authentication key issuance unit 3203 specifies the vehicle 10 that is a target of locking and unlocking using the authentication key or the key unit 12 corresponding to the vehicle 10. For example, the authentication key issuance unit 3203 specifies the authority of the authentication key regarding a period of time in which the authentication key is valid (available) and the number of times the authentication key is available. For example, the authentication key issuance unit 3203 specifies the authority of the authentication key regarding the unlocking or activation of the vehicle 10, such as lockable and unlockable doors and whether or not the vehicle 10 can be activated. For example, the authentication key issuance unit 3203 specifies the authority of the authentication key regarding the temporary key sharing, such as whether or not the authentication key can be shared with another mobile terminal 20 through a temporary key sharing to be described below, a period of time in which the authentication key can be shared with the other mobile terminal 20, and the number of times the authentication key can be shared with the other mobile terminal 20. Hereinafter, the authority of the authentication key regarding the period of time in which the authentication key is available, the number of times the authentication key is available, and the like, the authority of the authentication key regarding the unlocking or activation of the vehicle 10, and the authority of the authentication key regarding the temporary key sharing are collectively simply referred to as “various authorities of the authentication key”. The authentication key issuance unit 3203 distributes the authentication key issued to the mobile terminal 20 that is a target via the communication processing unit 3201.

Details of Configuration Regarding Key Sharing Service

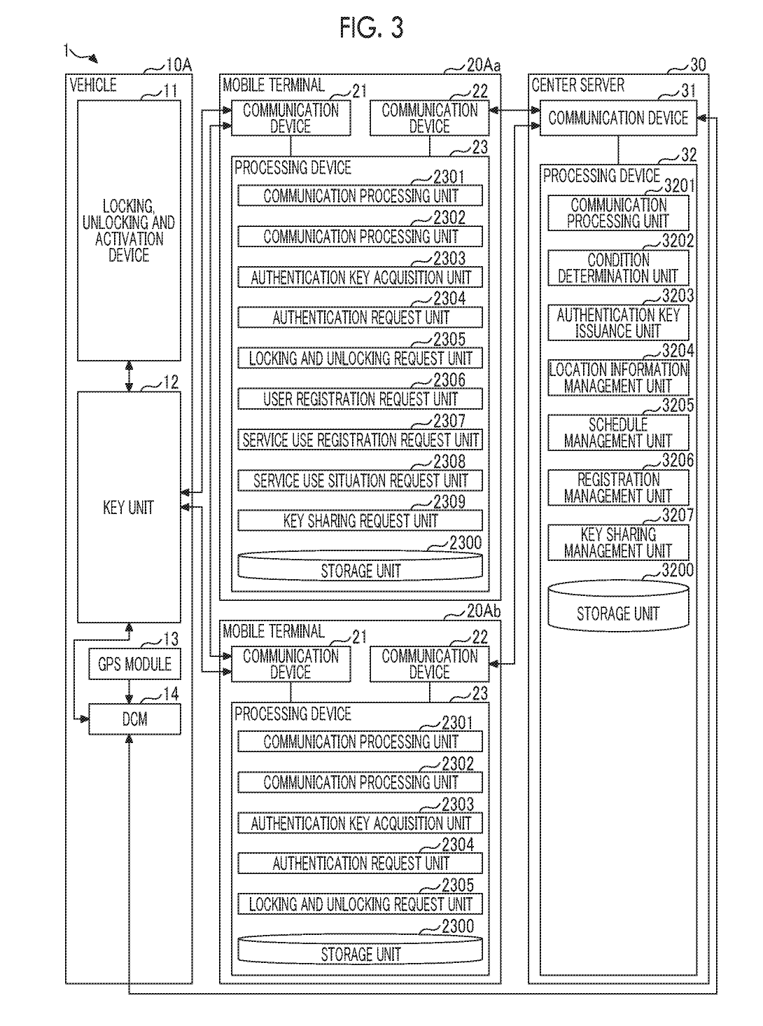

A configuration regarding the key sharing service in the authentication key management system 1 will be described with reference to FIG. 3.

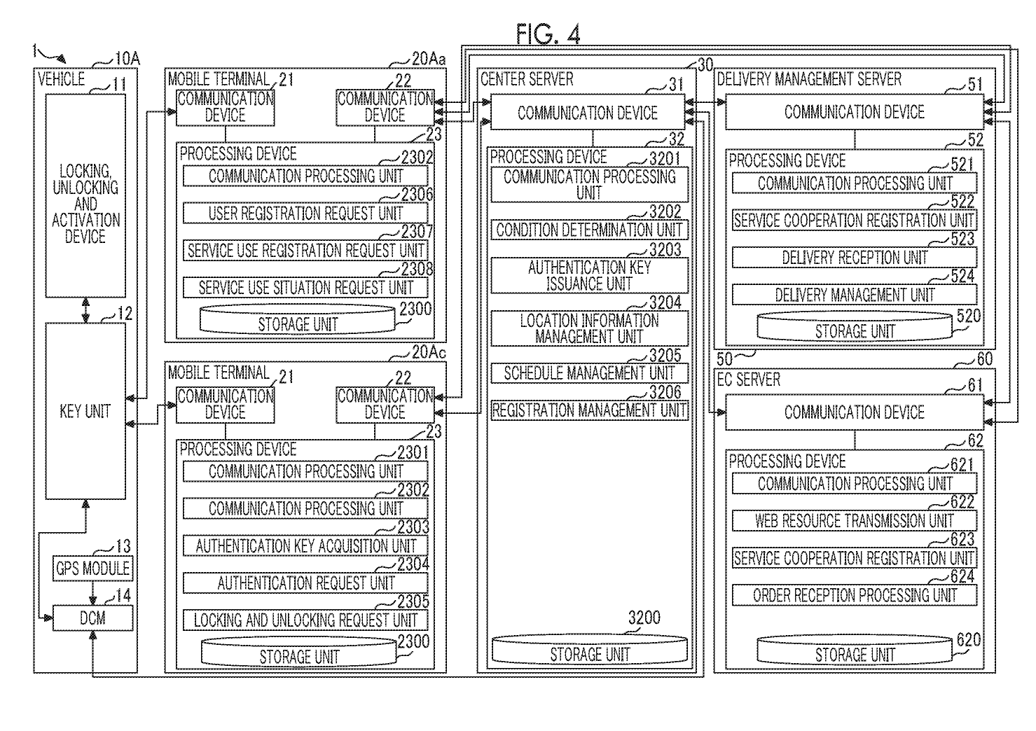

FIG. 3 is a diagram mainly illustrating an example of a configuration regarding the key sharing service in the authentication key management system 1. Hereinafter, a configuration regarding the key sharing service in the authentication key management system 1 will be mainly described with reference to FIG. 3, and duplicate description on the configuration overlapping the configuration regarding locking, unlocking, and activation of the vehicle 10 described above will be omitted as much as possible. Hereinafter, the same applies to description of FIGS. 4 to 6.

The processing device 23 of the mobile terminal 20Aa carried by the owner user of the vehicle 10A includes the communication processing unit 2301, the communication processing unit 2302, the authentication key acquisition unit 2303, the authentication request unit 2304, and the locking and unlocking request unit 2305, as described above. The processing device 23 of the mobile terminal 20Aa further includes a user registration request unit 2306, a service use registration request unit 2307, a service use situation request unit 2308, and a key sharing request unit 2309 as functional units that are realized by executing one or more programs stored in the ROM or the auxiliary storage device on the CPU.

In the embodiment, the description will be given on the premise that the functions of the user registration request unit 2306, the service use registration request unit 2307, the service use situation request unit 2308, and the key sharing request unit 2309 of the mobile terminal 20Aa are available to the owner user by the key application being activated and the user authentication based on bidirectional communication with the center server 30 being successful. The description will be given on the premise that the user authentication is performed by the center server 30 based on an ID defined for the owner user (hereinafter simply referred to as an “owner user ID”) in advance and a password corresponding to the owner user ID.

The user registration request unit 2306 requests the center server 30 to register the regular user of the vehicle 10A that uses various services (the key sharing service, the vehicle cabin delivery service, the C2C car sharing service, and the like) for using the vehicle 10A, according to a predetermined manipulation by the owner user. For example, the user registration request unit 2306 transmits a user registration request including an owner user ID and a password and attribute information (for example, a name, age, and relationship with the owner user) for specifying a sub-user who is a registration target to the center server 30 via the communication processing unit 2302.

When a notification indicating that registration of the sub-user has been completed (user registration completion notification) is received from the center server 30 by the communication processing unit 2302, the user registration request unit 2306 stores an ID (hereinafter simply referred to as a “sub-user ID”) and a password of the sub-user included in the user registration completion notification in the storage unit 2300. In this case, the user registration request unit 2306 may transmit the sub-user ID and the password to the mobile terminal 20Ab carried by the registered sub-user via the communication processing unit 2301 according to a predetermined manipulation by the owner user.

The service use registration request unit 2307 requests the center server 30 to perform registration of use of various services for using the vehicle 10A by the regular user of the vehicle 10A according to a predetermined manipulation by the owner user. That is, the service use registration request unit 2307 requests registration of the authentication key arrangement authority of the key sharing management unit 3207 or the service management server 40 corresponding to various services for allowing regular users of the vehicle 10A to use various services, as described above. For example, the service use registration request unit 2307 transmits a service use registration request including the owner user ID and the password, the information for specifying the vehicle 10A to be used for various services, the information for specifying the service that is a target, and the ID of the regular user who uses the target service (the owner user ID or the sub-user ID) to the center server 30 via the communication processing unit 2302. Hereinafter, the owner user ID and the sub-user ID may be collectively referred to as a “regular user ID”. Accordingly, the service use registration request unit 2307 can register a sub-user who uses the key sharing service in the center server 30.

The service use registration request unit 2307 receives a notification that the use registration of the service based on the service use registration request has been completed from at least one of the center server 30 and the service management server 40 through the communication processing unit 2302. The service use registration request unit 2307 causes the display 24 to display an indication that the use registration of the specific service by the regular user of the vehicle 10A based on the predetermined manipulation by the owner user has been completed. Accordingly, the owner user can figure out that the use registration of the specific service by the regular user has been completed.

The service use situation request unit 2308 requests the center server 30 to provide information on the use situation of various services (service use situation information) including the key sharing service by the regular user of the vehicle 10A for which the use registration has been completed in a form corresponding to the owner user ID according to a predetermined manipulation by the owner user. For example, the service use situation request unit 2308 transmits a service use situation request including the owner user ID and the password to the center server 30 via the communication processing unit 2302. When the service use situation information received from the center server 30 by the communication processing unit 2302 is received, the service use situation request unit 2308 displays the service use situation information on the display 24. Accordingly, the owner user can centrally figure out the information on the use situation of each service by each of the regular users registered for use in the center server 30 in an aspect in which the information is linked to the owner user ID.

The key sharing request unit 2309 requests the center server 30 to distribute the authentication key for performing locking, unlocking or activating of the vehicle 10A to the sub-user registered for use in the key sharing service according to a predetermined manipulation by the owner user. For example, the key sharing request unit 2309 transmits a key sharing request including an owner user ID and a password, information for specifying the vehicle 10A that is a locking and unlocking target by the authentication key, and information (for example, a sub-user ID) for specifying the sub-user that is a distribution (sharing) target of the authentication key to the center server 30 via the communication processing unit 2302. When the key sharing request unit 2309 transmits the key sharing request, use period information (for example, date and time of use start and date and time of use end) regarding a period of time in which the authentication key set and distributed by a predetermined manipulation by the owner user is available may be included in the key sharing request. The key sharing request may include authority information on various authorities of the authentication key, such as an authority of the authentication key regarding a period of time in which the authentication key is available or the number of times the authentication key is available, an authority of the authentication key regarding the unlocking or activation of the vehicle, and an authority of the authentication key regarding temporary key sharing to be described below, which can be designated according to the predetermined manipulation by the owner user. Accordingly, as described below, when the authentication key available at the same time is shared among the mobile terminals 20, the owner user can appropriately set authority information such that use of the vehicle 10A by a user other than the owner user can be limited. Therefore, security of the vehicle 10A can be improved.

The key sharing request unit 2309 may set the mobile terminals 20 (that is, at least one of the mobile terminals 20Aa, 20Ab) of a plurality of regular users of the vehicle 10A as distribution targets and request the center server 30 to distribute the authentication key of which the periods of time in which the authentication key is available overlap according to the predetermined manipulation by the owner user. That is, in the key sharing request, the regular users that are authentication key distribution targets may be designated, or the owner users may be included among the regular users. In the key sharing request, the period of time in which the authentication key is available for each of the designated regular users may overlap. Accordingly, the authentication key of the vehicle 10A available at the same time can be shared by the regular users. Therefore, for example, when a plurality of persons gets on the vehicle 10A together and go out for travel, camp, or the like, each of passengers can lock and unlock the vehicle 10A without renting the mobile terminal 20 in which the authentication key has been stored, and therefore, convenience for users can be improved.

Even when the key sharing request unit 2309 may share the distributed authentication key with another mobile terminal 20 (that is, the mobile terminal 20 in which the key application is installed) according to a predetermined manipulation by the owner user (hereinafter, a sharing aspect of the authentication key will be referred to as “temporary key sharing”). In this case, the other mobile terminal 20 may be the mobile terminal 20Ab of the sub-user or may be the mobile terminal 20 of a user other than the sub-user, that is, a user temporarily using the vehicle 10A.

For example, the key sharing request unit 2309 transmits the authentication key (more specifically, a copy of the authentication key) to another mobile terminal 20 via the communication processing unit 2301. Accordingly, the owner user of the vehicle 10A can share the authentication key with the other user even when a plurality of persons suddenly gets on the vehicle 10A together and go out for traveling or the like. It is possible to share the authentication key available at the same time with the other mobile terminal 20 directly from the mobile terminal 20Aa. Accordingly, for example, even when the mobile terminal 20Aa is at a place at which a communication situation in a wireless mobile communication network is poor or out of a communication range, the owner user of the vehicle 10A can share the authentication key with the other user.

In this case, the key sharing request unit 2309 may transmit the authentication key of which the authority regarding the period of time in which the authentication key is available or the number of times the authentication key is available or the authority regarding the unlocking or activation of the vehicle 10A, which is set based on the predetermined manipulation by the owner user or which is defined in advance, has been restricted, to the other mobile terminal 20 via the communication processing unit 2301. Specifically, for example, an authentication key with an authority to limit the period of time in which the authentication key is available or the number of times the authentication key is available to, for example, 30 minutes or once, or an authentication key with an authority, for example, solely to lock and unlock doors for getting on and off the vehicle 10A or prohibit activation of the vehicle 10A may be transmitted to another mobile terminal 20. Hereinafter, the same applies to the case of temporary key sharing that is performed via the center server 30. Accordingly, security of the vehicle 10A due to the temporary key sharing can be improved.

When the temporary key sharing is performed, the key sharing request unit 2309 may cause the authentication key to be distributed from the center server 30 to the other mobile terminal 20, as in a case of a normal key sharing. In this case, the key sharing request unit 2309 may transmit a temporary key sharing request including information (for example, an issued ID embedded in the authentication key) for specifying the distributed authentication key and information for designating the other mobile terminal 20 that is a distribution target to the center server 30 via the communication processing unit 2302, to cause the authentication key of the vehicle 10A to be distributed from the center server 30 to the other mobile terminal 20.

For example, when the other mobile terminal 20 is the mobile terminal 20Ab of the sub-user, the key sharing request unit 2309 may transmit a temporary key sharing request including the sub-user ID to the center server 30 via the communication processing unit 2302.

For example, the key sharing request unit 2309 acquires predetermined identification information (for example, a quick response (QR) code (registered trademark) corresponding to the user of another mobile terminal 20 registered as a user installing the key application in the center server 30) from the other mobile terminal 20 via the communication processing unit 2301. The key sharing request unit 2309 may transmit a temporary key sharing request for designating another mobile terminal 20 specified based on the identification information as a distribution target, to the center server 30.

The mobile terminal 20Aa may acquire the identification information using another method. For example, the mobile terminal 20Aa may acquire identification information corresponding to the user of the other mobile terminal 20 in an aspect in which the identification information displayed on the display 24 of the other mobile terminal 20 is recognized using a mounted camera function. For example, the mobile terminal 20Aa may acquire the identification information transmitted from the user of the other mobile terminal 20 to a mail address or an SNS account of the owner user.

For example, according to a predetermined manipulation by the owner user, the key sharing request unit 2309 transmits a candidate terminal information request for requesting a candidate terminal information on a candidate terminal that is a candidate for the other mobile terminal 20 present around a current location of the mobile terminal 20Aa to the center server 30 via the communication processing unit 2302. When the candidate terminal information is received from the center server 30 by the communication processing unit 2302, the key sharing request unit 2309 causes the display 24 to display the candidate terminal information. When the candidate terminal information is displayed on the display 24, information for specifying a candidate terminal in which a specific manipulation or operation is performed among candidate terminals may be included in the candidate terminal information replied from the center server 30. Accordingly, the owner user of the vehicle 10A can specify another mobile terminal 20 from among the candidate terminals displayed on the display 24 of the mobile terminal 20Aa by the user of the other mobile terminal 20 as a key sharing target performing a specific manipulation or operation with respect to the mobile terminal 20. The key sharing request unit 2309 may transmit a temporary key sharing request for designating the other mobile terminal 20 specified from among the candidate terminals as a distribution target to the center server 30, according to a predetermined manipulation by the owner user.

The key sharing request unit 2309 may activate the key application according to a predetermined manipulation by the owner user to transmit link information according to a uniform resource locator (URL) scheme for allowing the other mobile terminal 20 to acquire the authentication key from the center server 30 (hereinafter simply referred to as “link information”) to a mail address or an account of an SNS of the user of the other mobile terminal 20 via the communication processing unit 2302. In this case, the key sharing request unit 2309 transmits a temporary key sharing request for designating the acquired authentication key to the center server 30 via the communication processing unit 2302 according to a predetermined manipulation by the owner user, and acquires the link information replied from the center server 30 according to the temporary key sharing request. Accordingly, the key sharing request unit 2309 can cause the authentication key to be distributed from the center server 30 to the other mobile terminal 20.

The temporary key sharing may be executed from the mobile terminal 20Ab of the sub-user to which the authentication key has already been distributed. That is, a function regarding the temporary key sharing in the key sharing request unit 2309 may be included in a function of the key application that is installed in the processing device 23 of the mobile terminal 20Ab of the sub-user. Accordingly, it is not needed to rent the mobile terminal 20Ab of the sub-user who has acquired the authentication key even when a plurality of persons including no owner user gets on the vehicle 10A together, and convenience for the sub-user of the vehicle 10A can be further improved. Hereinafter, description will be given on the premise that the temporary key sharing can be performed from the mobile terminal 20Ab of the sub-user.

The processing device 32 of the center server 30 includes the communication processing unit 3201, the condition determination unit 3202, the authentication key issuance unit 3203, and the storage unit 3200, as described above. The processing device 32 of the center server 30 includes, for example, a location information management unit 3204, a schedule management unit 3205, a registration management unit 3206, and a key sharing management unit 3207 as functional units realized by executing one or more programs stored in an auxiliary storage device or the like of a server computer on a CPU.

When the authentication key acquisition request has been received from the mobile terminals 20Aa, 20Ab by the communication processing unit 3201, the condition determination unit 3202 performs authentication based on the regular user ID and the password included in the authentication key acquisition request. For example, the condition determination unit 3202 collates the regular user ID and password registered in the storage unit 3200 with the regular user ID and password included in the authentication key acquisition request, and determines that the authentication is successful, that is, the authentication key acquisition request is a regular authentication key acquisition request when both match.

The condition determination unit 3202 determines whether or not the authentication key arrangement request transmitted from the key sharing management unit 3207 to be described below is a regular authentication key arrangement request. For example, when the authentication is successful based on authentication information (for example, the ID and the password) included in the authentication key arrangement request from the key sharing management unit 3207, the condition determination unit 3202 may determine that the authentication key arrangement request is a regular authentication key arrangement request.

When the condition determination unit 3202 determines that the authentication key acquisition request or the authentication key arrangement request is a regular authentication key acquisition request or a regular authentication key arrangement request, the authentication key issuance unit 3203 issues the authentication key and distributes the authentication key to the mobile terminal 20 via the communication processing unit 3201.

The location information management unit 3204 manages the location information of the vehicles 10 (10A, 10B). Specifically, the location information management unit 3204 transmits a location information request to the vehicle 10 via the communication processing unit 3201. In response to the location information request, the DCM 14 of the vehicle 10 replies the center server 30 with the location information of the vehicle 10 input from the GPS module 13, and the location information management unit 3204 can acquire the location information of the vehicle 10.

The location information management unit 3204 acquires the location information from the vehicle 10A via the communication processing unit 3201 and monitors the location information of the vehicle 10A in real time to figure out a movement situation of the vehicle 10A. Accordingly, for example, the location information management unit 3204 can notify the owner user of the location information of the vehicle 10A rented to the sub-user via the communication processing unit 3201. For example, the location information management unit 3204 can notify the mobile terminal 20Ab of the sub-user of information such as whether or not the vehicle 10A scheduled to be rented to the sub-user is directed to a designated location (for example, home) or a reference for returning, via the communication processing unit 3201.

The schedule management unit 3205 manages the use situation of the vehicle 10A regarding various services. For example, the schedule management unit 3205 periodically acquires a use schedule of the vehicle 10 by the key sharing service and, specifically, information on date and time on which the authentication key distributed by the key sharing service is available, from the key sharing management unit 3207. The schedule management unit 3205 acquires the use schedule of the vehicle 10A by each of the vehicle cabin delivery service and the C2C car sharing service from the delivery management server 50 and the C2C car sharing management server 70 via the communication processing unit 3201. The schedule management unit 3205 generates information on the use schedule of the vehicle 10A (vehicle use schedule information) over a plurality of services based on the acquired use schedule of the vehicle 10A regarding the various services, and updates the vehicle use schedule information stored in the storage unit 3200.

The registration management unit 3206 performs registration of the regular user (the sub-user) who uses various services according to the user registration request received from the mobile terminal 20Aa of the owner user by the communication processing unit 3201. For example, the registration management unit 3206 collates the owner user ID and password included in the user registration request from the mobile terminal 20Aa with the owner user ID and password stored in the storage unit 3200, and determines that the user registration request is a regular user registration request when both match. That is, the registration management unit 3206 determines that the authentication is successful. The registration management unit 3206 registers the sub-user ID included in the regular user registration request in a user service registration information database (DB) in the storage unit 3200 as the regular user who can use various services.

The registration management unit 3206 performs registration of use of various services by the regular user of the vehicle 10A according to the service use registration request received from the mobile terminal 20Aa of the owner user by the communication processing unit 3201. That is, according to the service use registration request, the registration management unit 3206 performs registration of an authentication key arrangement authority of the key sharing management unit 3207 or the service management server 40 corresponding to various services to allow the user of the vehicle 10A to use various services. For example, the registration management unit 3206 performs the same authentication process as described above based on the owner user ID and the password included in the service use registration request from the mobile terminal 20Aa to determine whether the service use registration request is a regular service use registration request. When the service use registration request is a regular service use registration request, the registration management unit 3206 determines whether or not the regular user ID included in the service use registration request has already been registered in the user service registration information DB. When the regular user ID included in the service use registration request has already been registered in the user service registration information DB, the registration management unit 3206 registers the service of a target specified by the service use registration request in the user service registration information database (DB) in the storage unit 3200 as a service available to the regular user corresponding to the regular user ID.

Specifically, the registration management unit 3206 constructs a user service registration information DB in an aspect in which service-specific information for specifying a target service, vehicle-specific information for specifying the vehicle 10A, a regular user ID for specifying a regular user who uses the service, and service link information in which the vehicle-specific information corresponding to the vehicle 10A and the regular user ID are associated with the target service is linked to the owner user ID.

The service-specific information is, for example, a service ID that is defined for each service. Specifically, when a plurality of companies provides, for example, the C2C car sharing service, a unique service ID is defined for each of the companies. For example, when the same company provides a plurality of C2C car sharing services, a unique service ID is defined for each of the services provided by the same company. When a vehicle cabin delivery service is provided by a combination of a plurality of delivery companies and a plurality of EC companies, a unique service ID may be defined for each combination of the delivery company and the EC company, and the target service may be specified by a combination of the unique service ID defined for each of the delivery companies and a unique service ID defined for each of the EC companies.

The vehicle-specific information may be any information as long as the information is able to specify the vehicle 10A that is a target of locking, unlocking, or activation using the authentication key. For example, the vehicle-specific information may be identification information such as a vehicle ID or a vehicle identification number (VIN), which is defined for each vehicle 10A. For example, the vehicle-specific information may be identification information such as a key unit ID, which is defined for each in-vehicle device related to locking, unlocking, or activation of the doors based on the authentication key mounted on the vehicle 10A such as the key unit 12. Hereinafter, description will be given on the premise that the vehicle-specific information is the key unit ID.

The service link information is information needed for the key sharing management unit 3207, the delivery management server 50, the EC server 60, and the C2C car sharing management server 70 managing various services to transmit the authentication key arrangement request to thereby cause the authentication key issuance unit 3203 to issue the authentication key of the vehicle 10A that is a target and distribute the authentication key to the mobile terminal 20 that is a target. That is, the authentication key issuance unit 3203 can specify the vehicle 10A that is a target of locking, unlocking, or activation using the authentication key and issue an appropriate authentication key by receiving the authentication key arrangement request including the service link information from the key sharing management unit 3207, the delivery management server 50, the EC server 60, and the C2C car sharing management server 70.

The service link information may be any information as long as the target service is associated with the vehicle 10A and the user who uses the service in the center server 30. For example, the service link information may be a login ID of the regular user at a website for users of various services corresponding to the key sharing management unit 3207, the delivery management server 50, the EC server 60, and the C2C car sharing management server 70 (hereinafter referred to as a “service login ID” for convenience). In this case, the service use registration request unit 2307 of the mobile terminal 20Aa transmits the service use registration request including the service login ID of the regular user that is a registration target corresponding to the various services to the center server 30 via the communication processing unit 2302. When the regular user that is a registration target corresponding to various services does not acquire the service login ID, the processing device 23 of the mobile terminal 20Aa may activate a predetermined browser and acquire the service login ID of a website of various services. Accordingly, when the user (the regular user of the vehicle 10A) logs in to the website at the time of requesting a service that is a target, the delivery management server 50 or the C2C car sharing management server 70 can figure out the service login ID corresponding to the service link information and easily arrange the authentication key regarding the service provision. Hereinafter, description will be given on the premise that the service link information on the vehicle cabin delivery service and the C2C car sharing service is the service login ID.

In a case of regular users who regularly use a plurality of vehicles 10A, the center server 30 can specify the regular user solely by using the service login ID, but cannot specify the vehicle 10A. Therefore, information for indirectly specifying the vehicle 10A (for example, information obtained by encrypting the vehicle-specific information using a predetermined scheme) in addition to the service login ID may be included in the service link information.

When the registration of use of various services has been completed, registration management unit 3206 notifies the mobile terminals 20Aa, 20Ab corresponding to the regular users that are registration targets that the registration of use of various services has been completed, via the communication processing unit 3201. When the registration of use of various services has been completed, the registration management unit 3206 transmits, via the communication processing unit 3201, a service use registration completion notification including the service link information to the key sharing management unit 3207 or the service management server 40 that performs an operation and management of a service that is a registration target.

A notification that the registration of use of various services for the mobile terminals 20Aa, 20Ab has been completed may be transmitted from the service management server 40 that has received the service use registration completion notification.

When the service use situation request has been received from the mobile terminal 20Aa by the communication processing unit 3201, the registration management unit 3206 generates the service use situation information based on, for example, the vehicle use schedule information managed by the user service registration information DB of the storage unit 3200 or the schedule management unit 3205, and distributes the service use situation information to the mobile terminal 20Aa via the communication processing unit 3201.

The key sharing management unit 3207 performs an operation and management of the key sharing service.

For example, according to the key sharing request received from the mobile terminal 20Aa of the owner user by the communication processing unit 3201, the key sharing management unit 3207 performs the arrangement of the authentication key to the mobile terminals 20Aa, 20Ab corresponding to the regular user ID designated by the key sharing request. Specifically, the key sharing management unit 3207 collates the owner user ID and the password included in the key sharing request with the owner user ID and the password stored in the storage unit 3200, and determines that the key sharing request is a regular key sharing request when both match. The key sharing management unit 3207 inquires of the schedule management unit 3205 and determines whether or not there is mismatch, that is, overlapping of the use date and time regarding the use of the services and the vehicle 10A of the regular users between the use period information included in the key sharing request and the latest vehicle use schedule information. When there is no overlapping of the use time, the key sharing management unit 3207 transmits, to the authentication key issuance unit 3203, the authentication key arrangement request including information on the regular users corresponding to the mobile terminals 20Aa, 20Ab that are distribution targets of the authentication key specified by the information included in the key sharing request, and the vehicle 10A that is a target of locking, unlocking, or activation using the authentication key, and authority information such as a period of time in which the authentication key is available to the respective mobile terminals 20Aa, 20Ab, the number of times the authentication key is available to the respective mobile terminals 20Aa, 20Ab, unlockable doors, and whether or not the vehicle can be activated. Accordingly, the authentication key issuance unit 3203 can specify the regular user IDs corresponding to the mobile terminals 20Aa, 20Ab that are distribution targets of the authentication key, and the vehicle 10A that is a target of locking, unlocking, or activation using the authentication key, and issue an appropriate authentication key.

For example, the key sharing management unit 3207 confirms, for example, attribute information (for example, an age or presence or absence of a driving license) of the users of the mobile terminals 20Aa, 20Ab that are distribution targets of the authentication key that is designated by the key sharing request, which is stored in the storage unit 3200. When the users of the mobile terminal 20Aa, 20Ab (regular users of the vehicle 10A) that are distribution targets of the authentication key are users determined to be unable to drive the vehicle 10A, the key sharing management unit 3207 allows an authentication key to which an authority to be unable to activate the vehicle 10A has been imparted to be issued to the mobile terminal 20 of the user. The user who cannot drive the vehicle 10A is, for example, a user who has not reached an age at which the user can acquire a driver's license or a user who does not acquire the driver's license. Specifically, the key sharing management unit 3207 transmits an authentication key arrangement request in which an indication that the activation of the vehicle 10A is prohibited is included in authority information corresponding to the mobile terminals 20Aa, 20Ab corresponding to the users determined to be unable to drive the vehicle 10A, to the authentication key issuance unit 3203. Accordingly, since the authentication key issuance unit 3203 can distribute the authentication key to which the authority to prohibit the activation of the vehicle 10A has been imparted, to the mobile terminals 20Aa, 20Ab of the users who are unable to drive the vehicle 10A, it is possible to improve safety of the vehicle 10A in the key sharing service.

For example, the key sharing management unit 3207 distributes the authentication key of the vehicle 10A to the other mobile terminal 20 designated by the temporary key sharing request received from the mobile terminal 20Aa of the owner user by the communication processing unit 3201 based on the temporary key sharing request. Specifically, the key sharing management unit 3207 specifies the ID of the installing user corresponding to the other mobile terminal 20 that is a distribution target (hereinafter simply referred to as an “installing user ID”) based on the installing user information DB of the key application stored in the storage unit 3200. The key sharing management unit 3207 transmits an authentication key arrangement request including the specified installing user ID and information (for example, an issued ID of the authentication key included in the temporary key sharing request) corresponding to the authentication key designated by the temporary key sharing request to the authentication key issuance unit 3203. Accordingly, the authentication key issuance unit 3203 can specify another mobile terminal 20 that is a distribution target based on the installing user ID, the issued ID of the authentication key, and the like, and distribute the authentication key to the other mobile terminal 20 via the communication processing unit 3201.

A function of the key sharing management unit 3207 may be transferred to a server (a key sharing management server) outside the center server 30, which may be included in the service management server 40, similar to other services for using the vehicle 10A.

The mobile terminal 20Ab carried by the sub-user includes the communication processing unit 2301, the communication processing unit 2302, the authentication key acquisition unit 2303, the authentication request unit 2304, the locking and unlocking request unit 2305, and the storage unit 2300, as described above.

In the embodiment, description will be given on the premise that the function of the authentication key acquisition unit 2303 of the mobile terminal 20Ab is available to the sub-user by the key application being activated and the user authentication based on bidirectional communication with the center server 30 being successful. Description will be given on the premise that the user authentication is performed by the center server 30 based on the sub-user ID and the password. Description will be given on the premise that functions of the authentication request unit 2304 and the locking and unlocking request unit 2305 of the mobile terminal 20Ab are available to the sub-user by the key application being activated.

The authentication key acquisition unit 2303 acquires the authentication key distributed from the center server 30 according to the key sharing request transmitted from the mobile terminal 20Aa to the center server 30 via the communication processing unit 2302, as described above. Accordingly, the mobile terminal 20Ab can lock and unlock the doors of the vehicle 10A or activate the vehicle 10A based on the functions of the communication processing unit 2301, the authentication request unit 2304, and the locking and unlocking request unit 2305. That is, the sub-user carrying the mobile terminal 20Ab can directly use the vehicle 10A through the key sharing service. For example, the sub-user can lock and unlock the vehicle 10A using the mobile terminal 20Ab without performing key exchange with the owner user and drive the vehicle 10A. Similarly, the owner user can rent the vehicle 10A to the sub-user without exchanging the key with the sub-user. Accordingly, it is possible to improve convenience in rental of the vehicle 10A between the owner user of the vehicle 10A and the sub-user through the key sharing service in the authentication key management system 1.

The authentication key acquisition unit 2303 acquires the authentication key that is distributed from the center server 30 according to the temporary key sharing request transmitted from the mobile terminal 20Aa to the center server 30 via the communication processing unit 2302, as described above. The same applies to a case where the authentication key is distributed to another mobile terminal 20 other than the mobile terminal 20Ab of the sub-user according to the temporary key sharing request. Accordingly, the other mobile terminal 20 including the mobile terminal 20Ab can lock and unlock the doors of the vehicle 10A or activate the vehicle 10A based on the functions of the communication processing unit 2301, the authentication request unit 2304, and the locking and unlocking request unit 2305. That is, for example, when a plurality of persons including other regular users gets on the vehicle 10A together and goes out and even when the sub-user carrying the mobile terminal 20Ab does not acquire the authentication key in advance, the sub-user does not have to rent the mobile terminals 20Aa, 20Ab to which the authentication key has already been distributed, and can directly use the vehicle 10A using the mobile terminal 20Ab, such as locking and unlocking the vehicle 10A or driving the vehicle 10A. Similarly, even when the owner user has not caused the mobile terminal 20Ab of the sub-user to acquire the authentication key, it is not needed for the owner user to rent the mobile terminal 20Aa of the owner user to the sub-user. Accordingly, it is possible to improve convenience for the user in a case where a plurality of persons including the regular user of the vehicle 10A gets on the vehicle 10A together and uses the vehicle 10A through the temporary key sharing in the authentication key management system 1.

Details of Configuration Regarding Vehicle Cabin Delivery Service for Regular User

A configuration regarding the vehicle cabin delivery service for regular user in the authentication key management system 1 will be described with reference to FIG. 4.

FIG. 4 is a diagram mainly illustrating an example of a configuration regarding a vehicle cabin delivery service for regular user in the authentication key management system 1. Hereinafter, the configuration regarding the vehicle cabin delivery service for regular user in the authentication key management system 1 will be mainly described with reference to FIG. 4, and duplicate description on the configuration overlapping the above-described configuration regarding the key sharing service will be omitted as much as possible.

The processing device 23 of the mobile terminal 20Aa carried by the owner user of the vehicle 10A includes the communication processing unit 2302, the user registration request unit 2306, the service use registration request unit 2307, and the service use situation request unit 2308, as described above.

The user registration request unit 2306 requests the center server 30 to register the regular user (a sub-user) of the vehicle 10A who uses various services including the vehicle cabin delivery service according to a predetermined manipulation by the owner user, as described above.

The service use registration request unit 2307 requests the center server 30 to perform the registration of use of various services including the vehicle cabin delivery service for each registered regular user (the owner user or the sub-user) according to a predetermined manipulation by the owner user, as described above.

For example, the service use registration request unit 2307 transmits, as the service link information, a service use registration request for using the vehicle cabin delivery service including a service login ID of a website for a user who uses the service of the delivery management server 50 (hereinafter simply referred to as a “delivery site”) and a service login ID of the EC site, which corresponds to the regular user of the vehicle 10A that is a registration target, to the center server 30.

The service use situation request unit 2308 requests the center server 30 to provide information on a use situation of various services (service use situation information) including the vehicle cabin delivery service of the regular user of the vehicle 10A for which the use registration has been performed, in a form corresponding to the owner user ID according to a predetermined manipulation by the owner user, as described above.

The delivery management server 50 that performs an operation of the vehicle cabin delivery service for regular user includes a communication device 51 and a processing device 52.

The communication device 51 is any device that performs bidirectional communication with each of the mobile terminal 20, the center server 30, and the EC server 60 over a predetermined communication network.

The processing device 52 includes, for example, a communication processing unit 521, a service cooperation registration unit 522, a delivery reception unit 523, and a delivery management unit 524 as functional units that are realized by executing one or more programs stored in the ROM or the auxiliary storage device on the CPU. The processing device 52 includes a storage unit 520 that is realized as a storage area of an auxiliary storage device or the like of the server computer.

The communication processing unit 521 controls the communication device 51 to perform transmission and reception of various signals such as control signals or information signals to and from each of the mobile terminal 20, the center server 30, and the EC server 60.

The service cooperation registration unit 522 performs information registration for cooperation between the center server 30 regarding the use of the vehicle cabin delivery service of the regular user of the vehicle 10A and the delivery management server 50 according to the service use registration completion notification received from the center server 30 by the communication processing unit 521.

For example, the service cooperation registration unit 522 adds a flag indicating as a use target of the vehicle cabin delivery service for regular user to the service login ID (a part of service link information) of the delivery site included in the service use registration completion notification in the user management DB that manages the user of the delivery site constructed in the storage unit 520. In addition, the service cooperation registration unit 522 performs registration in an aspect in which information for specifying the vehicle 10A included in the service link information is linked to the service login ID included in the service use registration completion notification in the user management DB of the storage unit 520. Accordingly, when the user corresponding to the service login ID regularly uses the vehicles 10A, the delivery management server 50 transmits an authentication key arrangement request to the center server 30 for the vehicle 10A designated by the user. The delivery management server 50 transmits the authentication key arrangement request including service link information such as the specified service login ID of the delivery site or information for specifying the vehicle 10A corresponding to the vehicle 10A designated by the user to the center server 30 such that it is possible to cause the authentication key to be distributed from the center server 30 to the mobile terminal 20Ac of the deliverer, as described below.

The service cooperation registration unit 522 performs information registration for cooperation between the EC server 60 and the delivery management server 50 relating to use of the vehicle cabin delivery service for regular user in which the product ordered (purchased) at the EC site by the regular user of the vehicle 10A will be delivered.

For example, the service cooperation registration unit 522 performs registration in which a service login ID of a website (that is, the EC site) corresponding to the EC server 60 included in the service use registration completion notification is linked to the service login ID of the delivery site included in the service use registration completion notification in the user management DB of the storage unit 520. Accordingly, when a delivery request based on a product order reception including a service login ID of the EC site is received from the EC server 60, the delivery management server 50 can specify the corresponding service login ID of the delivery site.

The delivery reception unit 523 receives information (delivery request information) on the package delivery request including the service login ID of the EC site corresponding to an orderer of the product at the EC site from the EC server 60 via the communication processing unit 521. The delivery request information received from the EC server 60 includes information (for example, the service login ID of the delivery site or the EC site) for specifying the orderer out of those who are registered in the storage unit 520 in advance as users of the vehicle cabin delivery service for regular user. Moreover, the delivery request information includes basic information such as name, address, telephone number of the orderer corresponding to the delivery destination. The delivery request information also includes information (delivery destination information) on the designated delivery destination, information (scheduled delivery date-and-time information) on the scheduled delivery date and time designated by the orderer. For example, the delivery destination information includes information indicating that the vehicle 10A corresponding to the delivery destination is a vehicle regularly used by the client and information for specifying the vehicle 10A (for example, vehicle ID, etc.) when the delivery destination is designated as the trunk of the vehicle 10A that the client (regular user) regularly uses.

The delivery management unit 524 performs an operation and management of each process from reception to delivery regarding the delivery request received by the delivery reception unit 523.

For example, when the delivery management unit 524 receives a notification that package has reached a business office that has jurisdiction over a parking location of the vehicle 10A designated by the delivery destination information of the delivery request from the business office via the communication processing unit 521, the delivery management unit 524 chooses date and time of departure for delivery of the package, a deliverer in charge, and the like according to a designated delivery date and time (delivery date and time period).

The delivery management unit 524 inquires of the center server 30 about the location information of the vehicle 10A via the communication processing unit 521 before departure for the delivery of the package that is a target (for example, 10 minutes before the departure). The delivery management unit 524 acquires current location information of the vehicle 10A from the center server 30 via the communication processing unit 521 and determines whether or not the delivery is available from whether or not the current location matches the designated parking location of the vehicle 10A, a relationship between the current location and a jurisdiction area, or the like.

The determination as to whether or not the delivery is available may be made by the center server 30.

When the delivery management unit 524 determines that the delivery can be performed with respect to a package that is a target, the delivery management unit 524 transmits a notification that the package can be delivered to the trunk of the vehicle 10A (delivery available notification) to the mobile terminal 20Ac of the deliverer via the communication processing unit 521.

When an authentication key acquisition request is received from the mobile terminal 20Ac that has received the delivery available notification by the communication processing unit 521, the delivery management unit 524 determines whether or not the authentication key acquisition request is a regular authentication key acquisition request. Specifically, the delivery management unit 524 may perform the determination by collating information on a package that is a delivery target (hereinafter referred to as “delivery package information” for convenience) such as a deliverer, a destination (for example, a name of a recipient or a corporate name), a type of the package, a delivery time period, and a delivery place that can be included in the authentication key acquisition request, with various types of information on the package registered in the storage unit 520. When the delivery management unit 524 determines that the authentication key acquisition request is a regular authentication key acquisition request, the delivery management unit 524 transmits an authentication key arrangement request to the center server 30 via the communication processing unit 521. In this case, information for specifying the mobile terminal 20Ac of the deliverer may be included in the authentication key arrangement request. The information for specifying the deliverer may be, for example, an authentication ID for obtaining user authentication at the center server 30 in order for the deliverer to use the function of the key application corresponding to the authentication key acquisition unit 2303 of the mobile terminal 20Ac or the like (hereinafter referred to as a “deliverer ID” for convenience). Accordingly, the mobile terminal 20Ac of the deliverer can acquire the authentication key from the center server 30. Information for specifying the target package is included in the authentication key arrangement request.

Subsequently, the delivery management unit 524 receives an inquiry about the current location of the vehicle 10A from the mobile terminal 20Ac of the deliverer who has left for the delivery from the business office via the communication processing unit 521, the delivery management unit 524 inquires of the center server 30 about the current location information of the vehicle 10A. The delivery management unit 524 acquires the current location information of the vehicle 10A from the center server 30 via the communication processing unit 521 and transmits (transfers) the current location information of the vehicle 10A to the mobile terminal 20Ac of the deliverer. Accordingly, the deliverer who has gone out can compare the current location information of the vehicle 10A with the information on the parking location of the vehicle 10A designated by the delivery destination information and determine whether to deliver or return the package to the business office.

Finally, when the delivery management unit 524 receives a delivery completion notification received from the mobile terminal 20Ac of the deliverer who has completed the delivery of the package via the communication processing unit 521, the delivery management unit 524 transmits the delivery completion notification to the center server 30 via the communication processing unit 521 and basically ends an operation and management regarding the vehicle cabin delivery service regarding the package. When the operation and management regarding the vehicle cabin delivery service regarding the package are basically over, the delivery management unit 524 may notify the regular user of the vehicle 10A that is a client (a purchaser of a product at the EC site) through an electronic mail, a predetermined SNS, or a predetermined application program cooperating with the delivery site installed in the mobile terminals 20Aa, 20Ab that the delivery has been completed.

The DCM 14 of the vehicle 10A may determine that the delivery by the deliverer has been completed when the door (the trunk lid or the like) for access to the trunk of the vehicle 10A is locked after the door is unlocked by the unlocking request and the locking request transmitted from the mobile terminal 20Ac carried by the deliverer who has completed the delivery of the package, and notify the center server 30 that the delivery by the deliverer has been completed, as described above. Accordingly, the center server 30 can transmit a delivery completion notification to the delivery management server 50 when the notification is received. That is, the center server 30 may transmit a delivery completion notification to the delivery management server 50 in response to a message for notifying that the deliver has been completed, which is received by the deliverer from the vehicle 10A.

The EC server 60 includes a communication device 61 and a processing device 62.

The communication device 61 is any device that performs bidirectional communication with each of the mobile terminal 20, the center server 30, and the delivery management server 50 over a predetermined communication network.

The processing device 62 includes, for example, a communication processing unit 621, a web resource transmission unit 622, a service cooperation registration unit 623, and an order reception processing unit 624 as functional units that are realized by executing one or more programs stored in the ROM or the auxiliary storage device on the CPU. The processing device 62 includes a storage unit 620 that is realized as a storage area of an auxiliary storage device or the like of the server computer.

The communication processing unit 621 controls the communication device 61 to perform transmission and reception of various signals such as control signals or information signals to and from each of the mobile terminal 20, the center server 30, and the delivery management server 50.

The web resource transmission unit 622 transmits resources corresponding to the webpage to be displayed on any user terminal of the user browsing the EC site including the mobile terminal 20 (specifically, the mobile terminal 20Aa, the mobile terminal 20Ab, or the mobile terminal 20Ad) based on various types of information as resources of the EC site stored in the storage unit 620 to the user terminal using a predetermined scheme. The webpage to be displayed on the EC site may include a top page of the EC site, a webpage respectively corresponding to each product handled at the EC site (hereinafter simply referred to as an “individual product page”), a webpage for displaying a list of products (typically placed in a virtual cart on the EC site) selected by the user as may-be-purchased items (hereinafter simply referred to as a “cart page”), a webpage into which the user input various information upon ordering each product (that is, an “order input page”), etc.

When a predetermined application program (hereinafter simply referred to as an “EC application”), cooperating with the EC site and installed in the user terminal, is activated, the web resource transmission unit 622 transmits resources to be displayed on a predetermined window or screen (hereinafter collectively referred to as a “window”) of the EC application which is displayed on a display of the user terminal (for example, the display 24 of the mobile terminal 20), to the user terminal in a predetermined format. The window that may be displayed on the EC application includes a top window corresponding to the top page of the EC site described above, the individual product page, the cart page, the order input page or the like, an individual product window, a cart window, an order input window, etc.

For example, the web resource transmission unit 622 transmits a Hyper Text Markup Language (HTML) document corresponding to a webpage or a window of an EC application, and information under the HTML document such as an image and a moving image displayed on webpages or windows of the EC application in parallel.

The service cooperation registration unit 623 performs information registration for cooperation between the center server 30 regarding the use of the vehicle cabin delivery service of the regular user of the vehicle 10A and the EC server 60 according to the service use registration completion notification received from the center server 30 by the communication processing unit 621.

For example, the service cooperation registration unit 623 adds a flag indicating as a use target of the vehicle cabin delivery service to the service login ID of the EC site included in the service use registration completion notification in the user management DB that manages the user of the EC site constructed in the storage unit 620.

The service cooperation registration unit 623 performs information registration for cooperation between the EC server 60 and the delivery management server 50 regarding the use of the vehicle cabin delivery service for regular user, which delivers the product ordered (purchased) at the EC site by the regular user of the vehicle 10A.

For example, the service cooperation registration unit 623 registers (stores) in the storage unit 620 such that a service login ID of a website (that is, the delivery site) corresponding to the delivery management server 50 included in the service use registration completion notification is linked to the service login ID included in the service use registration completion notification in the user management DB of the storage unit 620. Accordingly, for example, when an inquiry about an ordered product including the service login ID of the delivery site is received from the delivery management server 50, the EC server 60 can specify the service login ID of the corresponding EC site.

The order reception processing unit 624 receives a product order from the user based on various input information related to the product order, which is input from the EC site accessed via a browser of the user terminal (for example, the mobile terminals 20Aa, 20Ab) or the EC application activated in the user terminal. In this case, when the trunk of the vehicle 10A is selected as a delivery destination on the order input page of the EC site or the order input window of the EC application, the order reception processing unit 624 inquires the center server 30 about the vehicle use schedule information via the communication processing unit 621. Accordingly, the order reception processing unit 624 can acquire the latest vehicle use schedule information via the communication processing unit 621. Therefore, for example, when a designated date and time of delivery has already overlapped another schedule, the order reception processing unit 624 can take countermeasures such as requesting to change a delivery date and time. Meanwhile, the order reception processing unit 624 chooses the trunk of the vehicle 10A as the delivery destination when vehicle use schedule information of the vehicle 10A corresponding to the designated (selected) delivery destination matches the designated delivery date and time.

As described above, the vehicle cabin delivery service for regular user in which a package other than the ordered product at the EC site is a target can also be assumed. In this case, the delivery management server 50 may receive a delivery request from the user via the delivery site accessed by a browser of the user terminal, or a predetermined application program (hereinafter simply referred to as a “delivery application”) activated by the user terminal in cooperation with the delivery site, as in a case of the EC server 60. The delivery management server 50 may receive a delivery request from the user, for example, via a terminal for receiving delivery request which is used by a staff of a business office of the delivery company to input information corresponding to the request according to the request the user who visits the business office. Moreover, the delivery management server 50 may acquire the latest vehicle use schedule information from the center server 30, as in a case of the EC server 60. Accordingly, the delivery management server 50 can take countermeasures such as requesting to change a delivery date and time when date and time of delivery of the package to the trunk of the vehicle 10A designated by the regular user of the vehicle 10A has already overlapped another schedule. The delivery management server 50 (for example, the delivery reception unit 523), in the same way as described above, may choose the trunk of the vehicle 10A as the delivery destination when vehicle use schedule information of the vehicle 10A corresponding to the designated (selected) delivery destination matches the designated delivery date and time.

The processing device 32 of the center server 30 that assists in an operation of the vehicle cabin delivery service for regular user includes the communication processing unit 3201, the condition determination unit 3202, the authentication key issuance unit 3203, the location information management unit 3204, the schedule management unit 3205, the registration management unit 3206, and the storage unit 3200, as described above.

When the condition determination unit 3202 receives the authentication key arrangement request from the delivery management server 50 via the communication processing unit 3201, the condition determination unit 3202 determines whether or not the authentication key arrangement request is a regular authentication key arrangement request. For example, the condition determination unit 3202 determines whether or not the authentication key arrangement request is the regular authentication key arrangement request based on service login information (the service login ID of the delivery site or the like) included in the authentication key arrangement request or predetermined authentication information (for example, the ID and the password) corresponding to the delivery management server 50.

When the condition determination unit 3202 determines that the authentication key arrangement request is a regular authentication key arrangement request, the authentication key issuance unit 3203 issues the authentication key corresponding to the regular authentication key arrangement request and distributes the authentication key to the mobile terminal 20Ac of the deliverer.

Specifically, the authentication key issuance unit 3203 specifies the vehicle 10A corresponding to the authentication key arrangement request based on the user service registration information DB of the storage unit 3200. The authentication key issuance unit 3203 issues the authentication key in which a time is limited (for example, the vehicle is available solely in units of several minutes to tens of minutes from the distribution), the number of times of use is limited (for example, the number of times of use is solely 1), and an authority is limited so that solely locking and unlocking of the trunk lid can be allowed. Accordingly, it is possible to suppress unauthorized use of the vehicle 10A by the deliverer and to improve security. The authentication key issuance unit 3203 distributes the authentication key to the mobile terminal 20Ac of the deliverer specified by the authentication key arrangement request via the communication processing unit 3201.

For example, any method such as a known mathematical method or a method based on bidirectional communication between the center server 30 and the vehicle 10 may be adopted as a method of limiting a period of time in which the authentication key is available or the number of times the authentication key is used.

In response to the inquiry about the current location of the vehicle 10 A from the delivery management server 50 received by the communication processing unit 3201, the location information management unit 3204, for example, acquires the location information from the vehicle 10A via the communication processing unit 3201 and provides (transmits) the location information to the delivery management server 50 via the communication processing unit 3201.

For example, the schedule management unit 3205 replies the EC server 60 with the latest vehicle use schedule information stored in the storage unit 3200 via the communication processing unit 3201 according to the inquiry from the EC server 60 received by the communication processing unit 3201.

The registration management unit 3206 performs registration of the regular user (the sub-user) who uses various services including the vehicle cabin delivery service according to the user registration request received from the mobile terminal 20Aa of the owner user by the communication processing unit 3201, as described above. The registration management unit 3206 performs registration of use of the vehicle cabin delivery service by the regular user of the vehicle 10A according to the service use registration request received from the mobile terminal 20Aa of the owner user by the communication processing unit 3201, as described above. When the registration of use of various services including the vehicle cabin delivery service has been completed, the registration management unit 3206 notifies the mobile terminals 20Aa, 20Ab corresponding to the regular users that are registration targets that the registration of use of various services including the vehicle cabin delivery service has been completed via the communication processing unit 3201, as described above. When the registration of use of the vehicle cabin delivery service has been completed, the registration management unit 3206 transmits a service use registration completion notification including the service link information to the delivery management server 50 and the EC server 60 that perform an operation and management of a service that is a registration target via the communication processing unit 3201.

The processing device 23 of the mobile terminal 20Ac of a deliverer includes the communication processing unit 2301, the communication processing unit 2302, the authentication key acquisition unit 2303, the authentication request unit 2304, and the locking and unlocking request unit 2305, as described above.

In the embodiment, the description will be given on the premise that the functions of the authentication key acquisition unit 2303, the authentication request unit 2304, and the locking and unlocking request unit 2305 of the mobile terminal 20Ac are available to the deliverer by the key application being activated.

The authentication key acquisition unit 2303 transmits the authentication key acquisition request to the delivery management server 50 via the communication processing unit 2302 according to a predetermined manipulation by a deliverer. In this case, the authentication key acquisition request includes the above-described delivery package information stored in the storage unit 2300 in advance. Accordingly, the delivery management server 50 transmits an authentication key arrangement request to the center server 30 according to the authentication key acquisition request, the center server 30 distributes the authentication key to the mobile terminal 20Ac according to the authentication key arrangement request, and the mobile terminal 20Ac can acquire the authentication key. Therefore, the mobile terminal 20Ac can lock and unlock the trunk lid of the vehicle 10A based on the functions of the communication processing unit 2301, the authentication request unit 2304, and the locking and unlocking request unit 2305, such that the deliverer can deliver the requested package to the trunk of the vehicle 10A, lock the trunk of the vehicle 10A, and return home.

Details of Configuration Regarding C2C Car Sharing Service

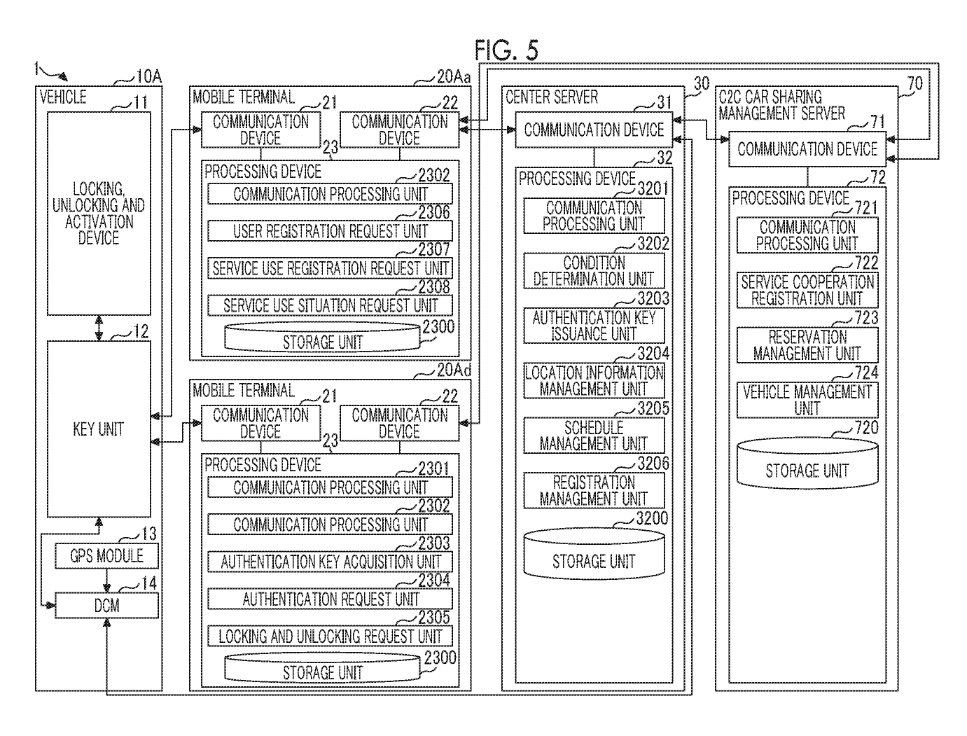

A configuration regarding a C2C car sharing service in the authentication key management system 1 will be described with reference to FIG. 5.

FIG. 5 is a diagram mainly illustrating an example of the configuration regarding the C2C car sharing service in the authentication key management system 1. Hereinafter, the configuration regarding the C2C car sharing service in the authentication key management system 1 will be mainly described with respect to FIG. 5, and duplicate description on the configuration overlapping the above-described configuration regarding the key sharing service or the like will be omitted as much as possible.

The processing device 23 of the mobile terminal 20Aa carried by the owner user of the vehicle 10A includes the communication processing unit 2302, the user registration request unit 2306, the service use registration request unit 2307, and the service use situation request unit 2308, as described above.

The user registration request unit 2306 requests the center server 30 to register the regular user (the sub-user) of the vehicle 10A who uses various services including the C2C car sharing service according to a predetermined manipulation by the owner user, as described above.

The service use registration request unit 2307 requests the center server 30 to perform the registration of use of various services including the C2C car sharing service for each registered regular user (the owner user or the sub-user) according to a predetermined manipulation by the owner user, as described above.

For example, the service use registration request unit 2307 transmits, as the service link information, a service use registration request for using the C2C car sharing service including a service login ID of a website for a user who uses the C2C car sharing service corresponding to the C2C car sharing management server 70 (hereinafter simply referred to as a “C2C car sharing site”), which corresponds to the regular user of the vehicle 10A that is a registration target, to the center server 30.

The service use situation request unit 2308 requests the center server 30 to provide information on a use situation of various services (service use situation information) including the C2C car sharing service of the regular user of the vehicle 10A for which the use registration has been performed, in a form corresponding to the owner user ID according to a predetermined manipulation by the owner user, as described above.

The C2C car sharing management server 70 includes a communication device 71 and a processing device 72.

The communication device 71 is any device that performs bidirectional communication with each of the mobile terminal 20 and the center server 30 over a predetermined communication network.

The processing device 72 includes, for example, a communication processing unit 721, a service cooperation registration unit 722, a reservation management unit 723, and a vehicle management unit 724 as functional units that are realized by executing one or more programs stored in the ROM or the auxiliary storage device on the CPU. The processing device 72 includes a storage unit 720 that is realized as a storage area of an auxiliary storage device or the like of the server computer.

Description will be given on the premise that the information for specifying the vehicle 10A that is a rental target has already been stored (registered) in the storage unit 720 in an aspect in which the information is linked to the service login ID via the C2C car sharing site by the regular user (the owner user) of the vehicle 10A. The same applies to the information on rental option of the vehicle 10A as the rental target.

The communication processing unit 721 controls the communication device 71 to perform transmission and reception of various signals such as control signals or information signals to and from each of the mobile terminal 20 and the center server 30.

The service cooperation registration unit 722 performs information registration for cooperation between the center server 30 regarding the use of the C2C car sharing service of the regular user of the vehicle 10A and the C2C car sharing management server 70 according to the service use registration completion notification received from the center server 30 by the communication processing unit 721.

For example, the service cooperation registration unit 722 adds a flag indicating a lessor of the vehicle 10A the C2C car sharing service to the service login ID included in the service use registration completion notification in the user management DB that manages the user of the C2C car sharing site constructed in the storage unit 720. The C2C car sharing management server 70 transmits the authentication key arrangement request including the service login ID corresponding to the regular user of the vehicle 10A, which is the lessor, to the center server 30 such that it is possible to cause the authentication key to be distributed from the center server 30 to the mobile terminal 20Ad of the lessee, as described below.

The reservation management unit 723 manages a reservation of use of the vehicle 10A that is performed through the C2C car sharing site which is accessed via a browser of the user terminal (for example, the mobile terminal 20Ad), or through an input terminal for accepting a rental reservation which is provided in a business office of a service provider of the C2C car sharing service visited by the user.

For example, the reservation management unit 723 accepts a registration of date and time on which the vehicle 10A is rentable and available rental option (specifically, whether either or both of the regular rental option and the trunk sharing rental option will be available) from the regular user of the vehicle 10A through the C2C car sharing site, and stores (registers) in the storage unit 720 the received date and time on which the vehicle 10A is rentable and the rental option. In this case, the reservation management unit 723 inquires of the center server 30 about the vehicle use schedule information via the communication processing unit 721. Accordingly, the reservation management unit 723 can acquire the latest vehicle use schedule information via the communication processing unit 721. Therefore, the C2C car sharing management server 70, for example, can take countermeasures such as requesting to change the date and time on which the vehicle 10A is rentable, which is received from the regular user of the vehicle 10A, or registering a portion excluding an overlapping portion from the date and time on which the vehicle 10A is rentable as the date and time on which the vehicle 10A is rentable when the received date and time on which the vehicle 10A is rentable already overlaps another schedule or registering.

For example, the reservation management unit 723 accepts from the user who is the lessee (hereinafter, referred to as a “lessee user” for convenience) a reservation of use of the vehicle 10A within a range of the available rental option and the date and time on which the vehicle 10A is rentable, which are stored in the storage unit 720. In this case, when one lessee user rents a part of the vehicle cabin of the vehicle 10A, that is, either the passenger compartment or the trunk portion with the trunk sharing rental option, the reservation management unit 723 may accept a reservation from another lessee user who wants to use a part of the vehicle cabin of the vehicle 10A, other than the rented part, because one of them uses the vehicle 10A merely as an accommodation place and thus it does not matter to him/her if another lessee user uses only a part of the vehicle cabin other than the part rented by him/her. Specifically, the reservation management unit 723 may accept the rental reservation from one lessee user with the trunk sharing rental option for allowing the user to use the trunk portion, while accepting rental reservation from another lessee user with the regular rental option for allowing the user to drive the vehicle 10A using the passenger compartment, or with the trunk sharing rental option for allowing the user to use the passenger compartment as the accommodation place.

The reservation management unit 723 performs a payment processing relating to payment of rental charge upon when accepting the rental reservation of the vehicle 10A from the lessee user through the C2C car sharing site. Specifically, the reservation management unit 723 performs the payment processing relating to payment of rental charge in accordance with a payment method designated by the lessee user through the C2C car sharing site. For example, the reservation management unit 723 carries out a payment processing, when the lessee user designates a credit card as a payment method, for accessing a transaction server corresponding to such a designated credit card to collect predetermined charges from the credit card. In this case, the reservation management unit 723 may carry out a payment processing, when accepting the rental reservation of the vehicle 10A from any lessee user with the trunk sharing rental option relating to the trunk portion, for collecting from such a lessee user a rental charge lower than that in a case receiving the rental reservation of the vehicle 10A with the regular rental option.

When the reservation management unit 723 accepts the reservation of rental of the vehicle 10A from a user who is a lessee through the C2C car sharing site, the reservation management unit 723 updates information on a rental schedule of the vehicle 10A (rental schedule information) stored in the storage unit 720. In this case, the reservation management unit 723 transmits the updated rental schedule information to the center server 30 via the communication processing unit 721, as described above. Accordingly, the center server 30 is capable of updating the latest vehicle use schedule information of the vehicle 10A rented by the C2C car sharing service.

The trunk portion and the passenger compartment may not be separated depending on a type of the vehicle 10A. Therefore, the reservation management unit 723 confirms the type of the vehicle 10A, and does not accept the rental reservations for the trunk portion and the passenger compartment at the same time when the vehicle 10A has the trunk portion and the passenger compartment which are not separated.

For example, when the authentication key acquisition request is received from the mobile terminal 20Ad of the lessee of the vehicle 10A by the communication processing unit 721, the reservation management unit 723 determines whether or not the authentication key acquisition request is a regular authentication key acquisition request. Specifically, the reservation management unit 723 may perform the determination based on the service login ID and the password of the C2C car sharing site included in the authentication key acquisition request, or a relationship regarding the date and time of reservation of use (for example, within a range of the date and time of reservation of use or less than a predetermined time until date and time of use start). When the authentication key acquisition request is a regular authentication key acquisition request, the reservation management unit 723 transmits an authentication key arrangement request to the center server 30 via the communication processing unit 721. In this case, information for specifying the mobile terminal 20Ad of the lessee of the vehicle 10A is included in the authentication key arrangement request. The information for specifying the lessee of the vehicle 10A may be, for example, an authentication ID (hereinafter referred to as a “lessee ID” for convenience) for obtaining user authentication in the center server 30 in order for the lessee of the vehicle 10A to use a function of the authentication key acquisition unit 2303 of the mobile terminal 20Ad. Accordingly, the mobile terminal 20Ad of the lessee of the vehicle 10A can acquire the authentication key from the center server 30. The authentication key arrangement request includes information on the rental option of the vehicle 10A (that is, information on whether the vehicle is rented with the regular rental option or the trunk sharing rental option). Accordingly, the center server 30 can grant different authorities concerning a function of the authentication key for locking/unlocking or activating the vehicle 10A, which is distributed to the mobile terminal 20Ad of the lessee, in accordance with the rental option of the vehicle 10A. Moreover, the authentication key arrangement request includes information on a part of the vehicle cabin rented by the lessee (the rental target for the lessee), i.e. information for specifying whether the rental target is the whole vehicle cabin, the passenger compartment or the trunk portion. Accordingly, the center server 30 can grant different authorities concerning a function of the authentication key for locking/unlocking the vehicle 10A, which is distributed to the mobile terminal 20Ad of the lessee, in accordance with the part of the vehicle cabin rented by the lessee.

The vehicle management unit 724 manages the vehicle 10A that is a rental target.

For example, the vehicle management unit 724 inquires of the center server 30 about a current location information of the vehicle 10A via the communication processing unit 721 before the date and time of reservation of use of the vehicle 10A (for example, a period from tens of minutes ago to immediately before). The vehicle management unit 724 acquires the current location information of the vehicle 10A replied from the center server 30 according to the inquiry via the communication processing unit 721. Accordingly, a determination can be made as to whether or not the vehicle 10A returns to a designated place before date and time of rental (date and time of reservation of use) of the vehicle 10A. Accordingly, when the vehicle 10A does not return to the designated place, the C2C car sharing management server 70 can take countermeasures such as warning the regular user who is a lessor of the vehicle 10A so that the vehicle 10A returns to the designated place through an e-mail or a predetermined application (for example, the key application, etc.) in cooperation with the C2C car sharing site, which is installed in the mobile terminals 20Aa, 20Ab.

The processing device 32 of the center server 30 includes the communication processing unit 3201, the condition determination unit 3202, the authentication key issuance unit 3203, the location information management unit 3204, the schedule management unit 3205, the registration management unit 3206, and the storage unit 3200, as described above.

When the authentication key arrangement request is received from the C2C car sharing management server 70 by the communication processing unit 3201, the condition determination unit 3202 determines whether or not the authentication key arrangement request is a regular authentication key arrangement request. For example, the condition determination unit 3202 determines whether or not the authentication key arrangement request is the regular authentication key arrangement request based on the service link information included in the authentication key arrangement request (for example, the service login ID of the C2C car sharing site) or predetermined authentication information (for example, the ID and the password) corresponding to the C2C car sharing management server 70.

When the condition determination unit 3202 determines that the authentication key arrangement request is a regular authentication key arrangement request, the authentication key issuance unit 3203 specifies the vehicle 10A corresponding to the authentication key arrangement request based on the user service registration information DB of the storage unit 3200. The authentication key issuance unit 3203 issues the authentication key in which a time is limited (for example, the vehicle is available solely at the date and time of reservation of use of the vehicle 10A included in the authentication key arrangement request and in a buffering period before and after such date and time). The authentication key issuance unit 3203 issues the authentication key having authority to lock/unlock or activate the vehicle 10A in accordance with the rental option and the rented part of the vehicle cabin of the vehicle 10A rented by the lessee, which are specified by the authentication key arrangement request. That is, the authentication key issuance unit 3203 issues, for example, the authentication key having authority to lock/unlock and active the door accessing the vehicle cabin of the vehicle 10A (whole vehicle cabin including the passenger compartment and the trunk portion, or including solely the passenger compartment), rented by the lessee, when the regular rental option is selected. Meanwhile, the authentication key issuance unit 3203 solely issues the authentication key having authority to lock/unlock the door corresponding to the rented part of the vehicle cabin, i.e. the door accessing the passenger compartment or the trunk of the vehicle 10A, when the trunk sharing rental option is selected. The authentication key issuance unit 3203 distributes the authentication key to the mobile terminal 20Ad of the lessee of the vehicle 10A specified by the issued authentication key arrangement request via the communication processing unit 3201.

The location information management unit 3204 transmits, for example, a location information request to the vehicle 10A via the communication processing unit 3201 according to the inquiry about the current location of the vehicle 10A received from the C2C car sharing management server 70 by the communication processing unit 3201.

Accordingly, the location information management unit 3204 can acquire the current location information from the vehicle 10A via the communication processing unit 3201. The location information management unit 3204 replies the C2C car sharing management server 70 with the current location information acquired from the vehicle 10A via the communication processing unit 3201.

The schedule management unit 3205 transmits the latest vehicle use schedule information to the vehicle 10A via the communication processing unit 3201 according to the inquiry about the current location of the vehicle 10A received from the C2C car sharing management server 70 by the communication processing unit 3201.

The registration management unit 3206 performs registration of the regular user (the sub-user) who uses various services including the C2C car sharing service according to the user registration request received from the mobile terminal 20Aa of the owner user by the communication processing unit 3201, as described above. The registration management unit 3206 performs registration of use of the C2C car sharing service by the regular user of the vehicle 10A according to the service use registration request received from the mobile terminal 20Aa of the owner user by the communication processing unit 3201, as described above. When the registration of use of various services including the C2C car sharing service has been completed, the registration management unit 3206 notifies the mobile terminals 20Aa, 20Ab corresponding to the regular users that are registration targets that the registration of use of various services including the C2C car sharing service has been completed via the communication processing unit 3201, as described above. When the registration of use of the C2C car sharing service has been completed, the registration management unit 3206 transmits a service use registration completion notification including the service link information to the C2C car sharing management server 70 that performs an operation and management of a service that is a registration target via the communication processing unit 3201.

The processing device 23 of the mobile terminal 20Ad of the lessee of the vehicle 10A includes the communication processing unit 2301, the communication processing unit 2302, the authentication key acquisition unit 2303, the authentication request unit 2304, the locking and unlocking request unit 2305, and the storage unit 2300, as described above.

The authentication key acquisition unit 2303 transmits an authentication key acquisition request to the C2C car sharing management server 70 via the communication processing unit 2302 according to a predetermined manipulation by the lessee of the vehicle 10A. In this case, the service login ID of the C2C car sharing site corresponding to the lessee of the vehicle 10A is included in the authentication key acquisition request. Accordingly, the C2C car sharing management server 70 can transmit an authentication key arrangement request to the center server 30 according to the authentication key acquisition request, the center server 30 can distribute the authentication key to the mobile terminal 20Ad according to the authentication key arrangement request, and the mobile terminal 20Ad can acquire the authentication key. Therefore, the mobile terminal 20Ad of the lessee can lock and unlock the door of the vehicle 10A (specifically, the door accessing the rented part of the vehicle cabin) based on functions of the communication processing unit 2301, the authentication request unit 2304 and the locking and unlocking request unit 2305, regardless of the rental option of the vehicle 10A. The mobile terminal 20Ad of the lessee can activate the vehicle 10A based on the functions of the communication processing unit 2301 the authentication request unit 2304, and the locking and unlocking request unit 2305 in a case of the regular rental option. That is, the lessee of the vehicle 10A carrying the mobile terminal 20Ad can directly use the vehicle 10A, such as locking and unlocking the vehicle 10A and driving the vehicle 10A using the mobile terminal 20Ad without performing exchange of a key with the regular user of the vehicle 10A through the C2C car sharing service. Similarly, the regular user of the vehicle 10A can rent out the vehicle 10A to another person other than the regular user without exchanging the key. Therefore, it is possible to improve convenience in rental of the vehicle 10A between the regular user of the vehicle 10A and another person other than the regular user through the C2C car sharing service in the authentication key management system 1.

Details of Configuration Regarding B2C Car Sharing Service

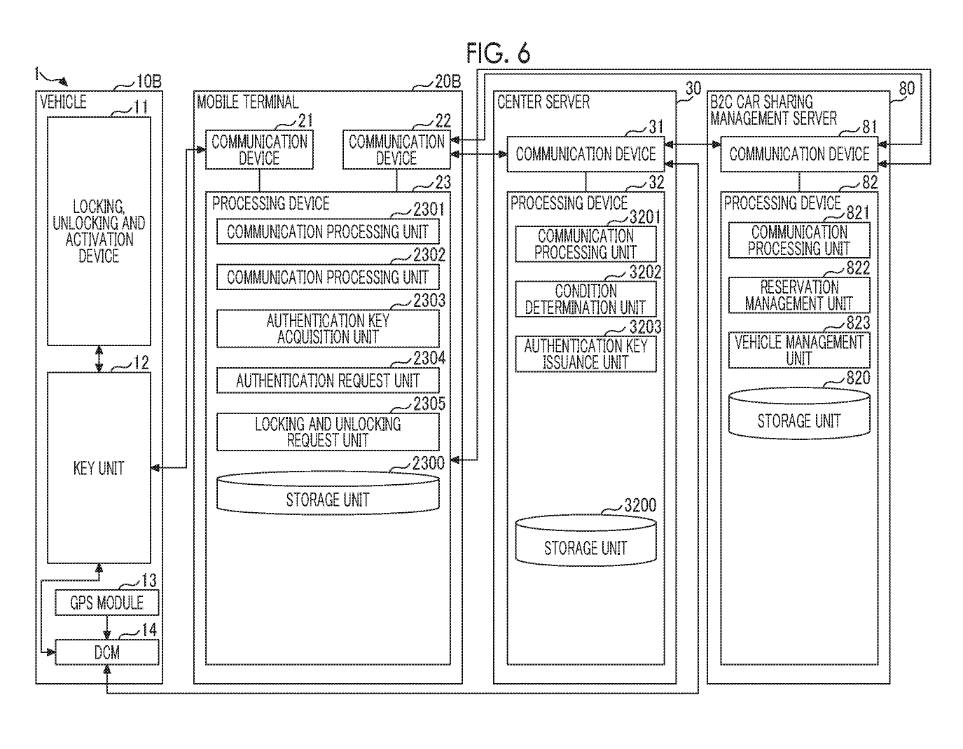

A B2C car sharing service in the authentication key management system 1 will be described with reference to FIG. 6.

FIG. 6 is a diagram mainly illustrating an example of the configuration regarding the B2C car sharing service in the authentication key management system 1. Hereinafter, the configuration regarding the B2C car sharing service in the authentication key management system 1 will be mainly described with respect to FIG. 6, and duplicate description on the configuration overlapping the above-described configuration regarding the key sharing service or the like will be omitted as much as possible.

The B2C car sharing management server 80 includes a communication device 81 and a processing device 82.

The communication device 81 is any device that performs bidirectional communication with each of the mobile terminal 20B and the center server 30 over a predetermined communication network.

The processing device 82 includes, for example, a communication processing unit 821, a reservation management unit 822, and a vehicle management unit 823 as functional units that are realized by executing one or more programs stored in the ROM or the auxiliary storage device on the CPU. The processing device 82 includes a storage unit 820 that is realized as a storage area of an auxiliary storage device or the like of the server computer.

The communication processing unit 821 controls the communication device 81 to perform transmission and reception of various signals such as control signals or information signals to and from each of the mobile terminal 20B and the center server 30.

The reservation management unit 822 manages a reservation of use of the vehicle 10B that is performed through a website for a user who uses the B2C car sharing service (hereinafter simply referred to as a “B2C car sharing site” for convenience) site which is accessed via a browser of the user terminal (an example of the user terminal of the car rental service; for example, the mobile terminal 20B), or through an input terminal (an example of the user terminal of the car rental service) for accepting a rental reservation which is provided in a business office of a service provider of the B2C car sharing service visited by the user.

For example, the reservation management unit 822 accepts a reservation (rental reservation) of use of the vehicle 10B from a user (hereinafter simply referred to as a “lessee user” for convenience) who wants to rent the vehicle 10B through a website that is operated by a company of the B2C car sharing site. In this case, when one lessee user rents either the passenger compartment or the trunk portion of the vehicle 10B with the trunk sharing rental option, the reservation management unit 822 may accept a reservation from another lessee user who wants to use a part of the vehicle cabin of the vehicle 10B, other than the rented part, at the same time as in a case of the C2C car sharing.

The reservation management unit 822 performs a payment processing relating to payment of rental charge upon when accepting the rental reservation of the vehicle 10B from the lessee user through the B2C car sharing site. Specifically, the reservation management unit 822 performs the payment processing relating to payment of rental charge in accordance with a payment method designated by the lessee user through the B2C car sharing site, as in a case of the C2C car sharing. In this case, the reservation management unit 822 may carry out a payment processing, when accepting the rental reservation of the vehicle 10B from any lessee user with the trunk sharing rental option relating to the trunk portion, for collecting from such a lessee user a rental charge lower than that in a case receiving the rental reservation of the vehicle 10B with the regular rental option, as in a case of the C2C car sharing.

The reservation management unit 822 stores information on the accepted reservation (rental reservation) of use of the vehicle 10B (use reservation information) in the storage unit 820. In this case, the use reservation information includes, for example, information for specifying the vehicle 10B as the rental target, information on date and time of the rental reservation (date and time of use start and date and time of use end for the rental vehicle), information on rental option of the vehicle 10B (specifically, information on whether the vehicle is rented with the regular rental option or the trunk sharing rental option), information on a part of the vehicle cabin rented by the lessee user of the vehicle 10B (specifically, information on whether the lessee user rents the whole vehicle cabin, the passenger compartment or the trunk portion), and the service login ID of the lessee user in the B2C car sharing site.

For example, the reservation management unit 822 updates the information on the rental schedule of the vehicle 10B (the vehicle rental schedule information) stored in the storage unit 820 each time the reservation management unit 822 accepts the reservation of rental of the vehicle 10B. Accordingly, the B2C car sharing management server 80 can display the use schedule of the vehicle 10B on the B2C car sharing site or the like, which can be browsed by the lessee user via a browser of the user terminal, to present date and time when the reservation of use can be made, to the lessee user.

For example, when the authentication key request is received from the mobile terminal 20B by the communication processing unit 821, the reservation management unit 822 determines whether or not the authentication key request is a regular authentication key request. Specifically, the reservation management unit 822 may perform the determination based on the service login ID and the password of the B2C car sharing site corresponding to the lessee user included in the authentication key request, or a relationship regarding the date and time of reservation of use (for example, within a range of the date and time of reservation of use or less than a predetermined time until date and time of use start). When the authentication key request is a regular authentication key acquisition request, the reservation management unit 822 transmits an authentication key arrangement request to the center server 30 via the communication processing unit 821. In this case, information for specifying the mobile terminal 20B of the lessee user renting the vehicle 10B is included in the authentication key arrangement request. The information for specifying the lessee user renting the vehicle 10B may be, for example, an authentication ID (hereinafter referred to as a “lessee user ID” for convenience) for obtaining user authentication in the center server 30 in order for the lessee user renting the vehicle 10B to use a function of a key application corresponding to the authentication key acquisition unit 2303 of the mobile terminal 20B or the like. Accordingly, the mobile terminal 20B of the lessee user renting the vehicle 10B can acquire the authentication key from the center server 30. The authentication key arrangement request includes information on the rental option of the vehicle 10B (that is, information for specifying whether it is the regular rental option or the trunk sharing rental option). Accordingly, the center server 30 can grant different authorities concerning a function of the authentication key for activating the vehicle 10B, which is distributed to the mobile terminal 20B of the lessee, in accordance with the rental option of the vehicle 10B. Moreover, the authentication key arrangement request includes information on a part of the vehicle cabin rented by the lessee (that is, information for specifying whether the rental target is the whole vehicle cabin, the passenger compartment or the trunk portion). Accordingly, the center server 30 can grant different authorities concerning a function of the authentication key for locking/unlocking the vehicle 10B, which is distributed to the mobile terminal 20B of the lessee user, in accordance with the part of the vehicle cabin rented by the lessee.

The vehicle management unit 823 manages the vehicle 10B that is a rental target.

For example, the vehicle management unit 823 inquires of the center server 30 about the vehicle 10B parked in the vicinity (for example, within hundreds of meters) of a place designated in the reservation of use via the communication processing unit 821 before the date and time of reservation of use of the vehicle 10B of a lessee user (for example, before tens of minutes). The vehicle management unit 823 acquires the location information of the vehicle 10B parked in the vicinity of the designated place replied from the center server 30 according to the inquiry via the communication processing unit 821. Accordingly, the vehicle management unit 823 can specify one or a plurality of vehicles 10B parked around the designated place and determine, for example, the vehicle 10B to be rented before the start date and time of use of the vehicle 10B of the lessee.

For example, the vehicle management unit 823 inquires of the center server 30 about the location information of the vehicle 10B in the designated area via the communication processing unit 821 according to a search request of the vehicle 10B in a designated area by the lessee user at the B2C car sharing site. The vehicle management unit 823 acquires the location information of the vehicle 10B in the designated area replied from the center server 30 according to the inquiry via the communication processing unit 821. Accordingly, the vehicle management unit 823, for example, can present the location information of the vehicle 10B that is a target to the lessee user who wants to rent the vehicle 10B in the designated area immediately at the B2C car sharing site.

The processing device 32 of the center server 30 includes the communication processing unit 3201, the condition determination unit 3202, the authentication key issuance unit 3203, and the storage unit 3200, as described above.

When the authentication key arrangement request received from the B2C car sharing management server 80 is received by the communication processing unit 3201, the condition determination unit 3202 determines whether or not the authentication key arrangement request is a regular authentication key arrangement request. For example, the condition determination unit 3202 determines whether or not the authentication key arrangement request is the regular authentication key arrangement request based on whether or not the lessee user ID included in the authentication key arrangement request is the authentication ID already registered in the storage unit 3200, or on predetermined authentication information (for example, an ID Password) corresponding to the B2C car sharing management server 80.

When the condition determination unit 3202 determines that the authentication key arrangement request is the regular authentication key arrangement request, the authentication key issuance unit 3203 issues the authentication key in which a time is limited (for example, the vehicle is available solely at the date and time of reservation of use of the vehicle 10B included in the authentication key arrangement request and in a buffering period before and after such date and time). The authentication key issuance unit 3203 issues the authentication key having authority to lock/unlock or activate the vehicle 10B in accordance with the rental option and the rented part of the vehicle cabin of the vehicle 10B rented by the lessee, which are specified by the authentication key arrangement request. That is, the authentication key issuance unit 3203 issues, for example, the authentication key having authority to lock/unlock and active the door accessing the vehicle cabin of the vehicle 10B (whole vehicle cabin including the passenger compartment and the trunk portion, or including solely the passenger compartment), rented by the lessee, when the regular rental option is selected. Meanwhile, the authentication key issuance unit 3203 solely issues the authentication key having authority to lock/unlock the door corresponding to the rented part of the vehicle cabin, i.e. the door accessing the passenger compartment or the trunk of the vehicle 10B, when the trunk sharing rental option is selected. The authentication key issuance unit 3203 distributes the authentication key to the mobile terminal 20B of the lessee user renting the vehicle 10B specified by the authentication key arrangement request via the communication processing unit 3201.

The processing device 23 of the mobile terminal 20B of the lessee user renting the vehicle 10B includes the communication processing unit 2301, the communication processing unit 2302, the authentication key acquisition unit 2303, the authentication request unit 2304, the locking and unlocking request unit 2305, and the storage unit 2300, as described above.

The authentication key acquisition unit 2303 transmits an authentication key acquisition request to the B2C car sharing management server 80 via the communication processing unit 2302 according to a predetermined manipulation by the lessee user of the vehicle 10B. In this case, the service login ID of the B2C car sharing site corresponding to the lessee user renting the vehicle 10B is included in the authentication key acquisition request. Accordingly, the B2C car sharing management server 80 can transmit an authentication key arrangement request to the center server 30 according to the authentication key acquisition request, the center server 30 can distribute the authentication key to the mobile terminal 20B according to the authentication key arrangement request, and the mobile terminal 20B can acquire the authentication key. Therefore, the mobile terminal 20B of the lessee can lock and unlock the door of the vehicle 10B (specifically, the door accessing the rented part of the vehicle cabin) based on functions of the communication processing unit 2301, the authentication request unit 2304 and the locking and unlocking request unit 2305, regardless of the rental option of the vehicle 10B. The mobile terminal 20B of the lessee can activate the vehicle 10B based on the functions of the communication processing unit 2301, the authentication request unit 2304, and the locking and unlocking request unit 2305 in a case of the regular rental option. That is, the lessee user renting the vehicle 10B carrying the mobile terminal 20B can directly use the vehicle 10B, such as locking and unlocking the vehicle 10B and driving the vehicle 10B using the mobile terminal 20B without performing exchange of a key with the company of the vehicle 10B through the B2C car sharing service. Therefore, it is possible to improve convenience for the lessee user renting the vehicle 10B through the B2C car sharing service in the authentication key management system 1.

Details of Configuration Regarding Vehicle Cabin Delivery Service for Lessee User

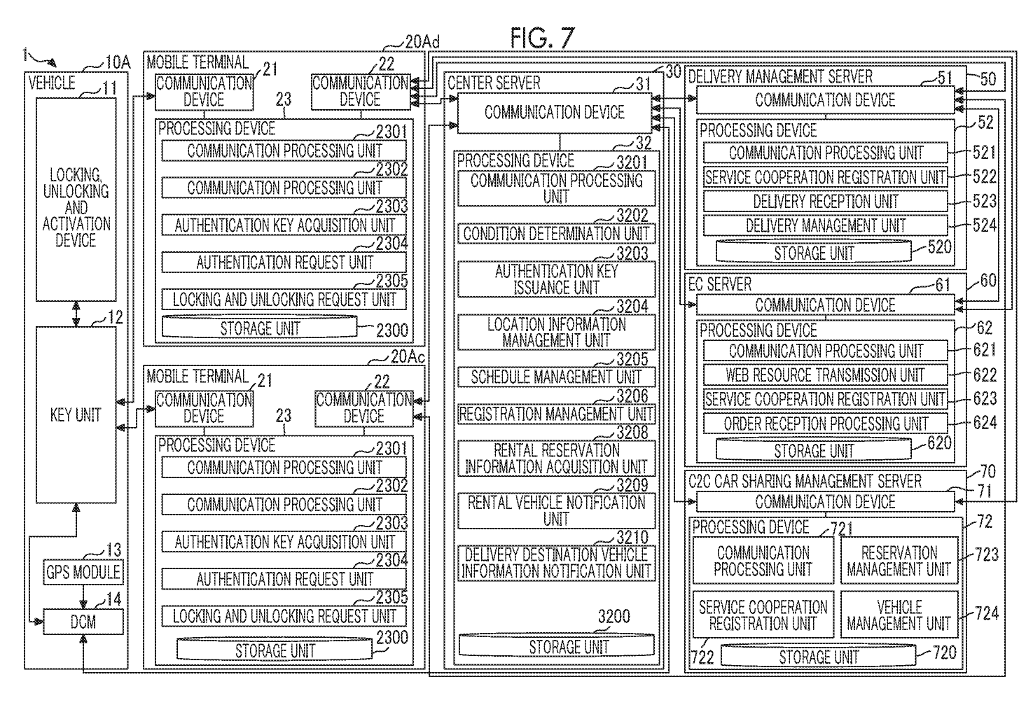

A configuration regarding the vehicle cabin delivery service for lessee user in the authentication key management system 1 will be described with reference to FIG. 7.

FIG. 7 is a diagram mainly illustrating an example of a configuration regarding a vehicle cabin delivery service for lessee user in the authentication key management system 1. Specifically, FIG. 7 is a diagram focusing an example of a configuration regarding a vehicle cabin delivery service for lessee user of which client is a lessee user who rents the vehicle 10A by the C2C car sharing service operated by the C2C car sharing management server 70. Hereinafter, the configuration regarding the vehicle cabin delivery service in the authentication key management system 1 will be mainly described with reference to FIG. 7, and duplicate description on the configuration overlapping the above-described configuration regarding the key sharing will be omitted.

A configuration regarding a vehicle cabin delivery service for lessee user of which client is a lessee user who rents the vehicle 10B by the B2C car sharing service operated by the B2C car sharing management server 80 is implemented by replacing the vehicle 10A and the C2C car sharing management server 70 of FIG. 7 with the vehicle 10B and the B2C car sharing management server 80. Moreover, since the specific configurations of the vehicle 10A and the C2C car sharing management server 70 to be described later can be applied to the specific configurations of the vehicle 10B and the B2C car sharing management server 80 in the vehicle delivery service for lessee user of which client is a lessee user who rents the vehicle 10B, thus the description will be omitted.

The delivery management server 50 that performs an operation of the vehicle cabin delivery service for lessee user includes a communication device 51 and a processing device 52.

The processing device 52 includes the communication processing unit 521, the service cooperation registration unit 522, the delivery reception unit 523, the delivery management unit 524, and the storage unit 520, as described above.

The service cooperation registration unit 522 performs information registration for cooperation between the EC server 60 and the delivery management server 50 relating to use of the vehicle cabin delivery service for lessee user in which the product ordered (purchased) at the EC site by the lessee user of the vehicle 10A rented by the C2C car sharing service will be delivered.

For example, the service cooperation registration unit 522 registers (stores) in the storage unit 520 such that a service login ID of the lessee user in the delivery site which has been registered in the storage unit 520 is linked to a service login ID of the EC site registered by the lessee user via the delivery site. Specifically, the service cooperation registration unit 522 inquires of the EC server 60 for user confirmation via the communication processing unit 521 based on the service login ID and the password of the EC site, which have been registered by the lessee user via the delivery site. Furthermore, the service cooperation registration unit 522 registers (stores) in the storage unit 520, specifically, such that the service login ID of the delivery site is linked to the service login ID of the EC site registered by the lessee user via the delivery site when the authentication success is notified from the EC server 60 via the communication processing unit 521. Accordingly, when a delivery request based on a product order reception including a service login ID of the EC site is received from the EC server 60, the delivery management server 50 can specify the service login ID of the delivery site corresponding to the client of the delivery request (orderer of the product).

The service cooperation registration unit 522 performs information registration for cooperation between the C2C car sharing management server 70 and the delivery management server 50 relating to use of the vehicle cabin delivery service for lessee user.

For example, the service cooperation registration unit 522 adds a flag indicating as a use target of the vehicle cabin delivery service for lessee user to the service login ID of the lessee user in the delivery site which has been registered in the storage unit 520 based on the service login ID of the C2C car sharing site registered by the lessee user via the delivery site. Specifically, the service cooperation registration unit 522 inquires of the C2C car sharing management server 70 for user confirmation via the communication processing unit 521 based on the service login ID and the password of the C2C site, which have been registered by the lessee user via the delivery site. Furthermore, the service cooperation registration unit 522 registers (stores) in the storage unit 520, specifically, such that the service login ID of the delivery site is linked to the service login ID of the C2C car sharing site registered by the lessee user via the delivery site and a flag indicating as a use target of the vehicle cabin delivery service for lessee user is added, when the authentication success is notified from the C2C car sharing server 70 via the communication processing unit 521. Accordingly, when the information on the rental reservation of the vehicle 10A including the service login ID of the C2C car sharing site for specifying the lessee user is received from the C2C car sharing management server 70, the delivery management server 50 can, for example, specify the service login ID of the delivery site corresponding to the lessee of the vehicle 10A as the rental reservation target, and confirm whether or not such a lessee is a use target of the vehicle cabin delivery service for lessee user.

The delivery reception unit 523 receives information (delivery request information) on the delivery request of the product (package) ordered at the EC site from the EC server 60 via the communication processing unit 521. The delivery request information received from the EC server 60 includes information (for example, the service login ID of the delivery site, the EC site or the C2C car sharing site) for specifying the orderer out of those who are registered in the storage unit 520 in advance as users of the vehicle cabin delivery service for lessee user. Moreover, the delivery request information includes basic information such as name, address, telephone number of the orderer. The delivery request information also includes information (delivery destination information) on the designated delivery destination, information (delivery date-and-time information) on the delivery date and time designated by the orderer. For example, the delivery destination information includes information indicating that the vehicle 10A corresponding to the delivery destination is a vehicle rented by the C2C car sharing service and information for specifying the vehicle 10A (for example, vehicle ID, etc.) when the delivery destination is designated as the trunk of the vehicle 10A rented by the C2C car sharing service.

The delivery management unit 524 performs an operation and management of each process from reception to delivery regarding the delivery request received by the delivery reception unit 523. The specific operations of the delivery management unit 524 in the vehicle delivery service for lessee user will be omitted since such operations are the same as those in the vehicle delivery service for regular user described above, except for that the transmission destination of the delivery completion notification is replaced with the lessee of the vehicle 10A from the regular user of the vehicle 10A.

The EC server 60 includes the communication device 61 and the processing device 62, as described above.

The processing device 62 includes the communication processing unit 621, the web resource transmission unit 622, the service cooperation registration unit 623, the order reception processing unit 624, and the storage unit 620, as described above.

The service cooperation registration unit 623 performs information registration for cooperation between the EC server 60 and the delivery management server 50 relating to use of the vehicle cabin delivery service for lessee user in which the product ordered (purchased) at the EC site by the lessee user of the vehicle 10A rented by the C2C car sharing service will be delivered.

For example, the service cooperation registration unit 623 registers (stores) in the storage unit 620 such that a service login ID of the lessee user in the EC site which has been registered in the storage unit 620 is linked to a service login ID of the delivery site registered by the lessee user via the EC site. Specifically, the service cooperation registration unit 623 inquires of the delivery management server 50 for user confirmation via the communication processing unit 621 based on the service login ID and the password of the EC site, which have been registered by the lessee user via the EC site. Furthermore, the service cooperation registration unit 623 registers (stores) in the storage unit 620, specifically, such that the service login ID of the EC site is linked to the service login ID of the delivery site registered by the lessee user via the EC site when the authentication success is notified from the delivery management server 50 via the communication processing unit 621. Accordingly, for example, when an inquiry about an ordered product including the service login ID of the delivery site is received from the delivery management server 50, the EC server 60 can specify the service login ID of the EC site corresponding to the orderer of the ordered product, etc.

The service cooperation registration unit 623 performs information registration for cooperation between the C2C car sharing management server 70 and the EC server 60 relating to use of the vehicle cabin delivery service for lessee user.

For example, the service cooperation registration unit 623 adds a flag indicating as a use target of the vehicle cabin delivery service for lessee user to the service login ID of the lessee user in the EC site which has been registered in the storage unit 620 based on the service login ID of the C2C car sharing site registered by the lessee user via the EC site. Specifically, the service cooperation registration unit 623 inquires of the C2C car sharing management server 70 for user confirmation via the communication processing unit 621 based on the service login ID and the password of the C2C site, which have been registered by the lessee user via the EC site. Furthermore, the service cooperation registration unit 623 registers (stores) in the storage unit 620, specifically, such that the service login ID of the EC site is linked to the service login ID of the C2C car sharing site registered by the lessee user via the EC site and a flag indicating as a use target of the vehicle cabin delivery service for lessee user is added, when the authentication success is notified from the C2C car sharing server 70 via the communication processing unit 621. Accordingly, when the delivery request designating the trunk of the vehicle 10A rented by the lessee user with the C2C car sharing service as the delivery destination is received, the EC server 60 can confirm whether or not such a lessee is a use target of the vehicle cabin delivery service for lessee user based on the service login ID of the C2C car sharing site included in the delivery request.

The order reception processing unit 624 (an example of the delivery destination choosing unit) receives a product order from the user based on various input information related to the product order, which is input from the EC site accessed via a browser of the user terminal (an example of the user terminal of the delivery service; for example, the mobile terminal 20Ad, etc.) or the EC application activated in the user terminal. In this case, when the trunk of the vehicle 10A rented by the C2C car sharing service is selected as a delivery destination on the order input page of the EC site or the order input window of the EC application, the order reception processing unit 624 acquires information on a rental reservation of the vehicle 10A and a reservation date and time from the center server 30 or the C2C car sharing management server 70 via the communication processing unit 621. Accordingly, the order reception processing unit 624 can determine whether or not the vehicle 10A corresponding to the delivery destination is properly reserved, and whether or not the reservation date and time includes the designated delivery date and time. Therefore, the order reception processing unit 624 can take measures, such as requesting the user to change the delivery destination or delivery date and time on the EC site when the designated vehicle 10A is improperly reserved or when the designated date and time is not included in the reservation date and time. Meanwhile, the order reception processing unit 624 chooses the trunk of the vehicle 10A rented by the C2C car sharing service as the delivery destination when the rental reservation of the vehicle 10A corresponding to the designated (selected) delivery destination is properly completed.

As described above, the vehicle cabin delivery service for lessee user in which a package other than the ordered product at the EC site is a target can also be assumed. In this case, the delivery management server 50 may receive the delivery request from the user in accordance with the request input by a user terminal (an example of the user terminal of the delivery service) or by a terminal (an example of the user terminal of the delivery service) for receiving delivery request which is provided in a business office of the delivery company visited by the user, as described above. The delivery management server 50 may acquire information on a rental reservation of the vehicle 10A and a reservation date and time from the center server 30 or the C2C car sharing management server 70, as in a case of the EC server 60. Accordingly, the delivery management server 50 can take measures the same as those taken by the EC server 60 (the order reception processing unit 624). Furthermore, the delivery management server 50 (for example, the delivery reception unit 523; an example of the delivery destination choosing unit) may choose the trunk of the vehicle 10A rented by the C2C car sharing service as the delivery destination of the product when the rental vehicle 10A corresponding to the designated (selected) delivery destination is properly reserved, as described above.

The processing device 72 of the C2C car sharing management server 70 that assists in an operation of the vehicle cabin delivery service for lessee user includes the communication processing unit 721, the service cooperation registration unit 722, the reservation management unit 723, the vehicle management unit 724, and the storage unit 720, as described above.

The service cooperation registration unit 722 performs information registration for cooperation between the delivery management server 50 and the C2C car sharing management server 70 relating to use of the vehicle cabin delivery service for lessee user.

For example, the service cooperation registration unit 722 registers (stores) in the storage unit 720 such that a service login ID of the lessee user in the C2C car sharing site which has been registered in the storage unit 720 is linked to a service login ID of the delivery site registered by the lessee user via the C2C car sharing site. Specifically, the service cooperation registration unit 722 inquires of the delivery management server 50 for user confirmation via the communication processing unit 721 based on the service login IDs and the passwords of the delivery site and the EC site, which have been registered by the lessee user via the C2C car sharing site. Furthermore, the service cooperation registration unit 722 registers (stores) in the storage unit 720, specifically, such that the service login ID of the C2C car sharing site is linked to the service login ID of the delivery site registered by the lessee user via the C2C car sharing site when the authentication success is notified from the delivery management server 50 via the communication processing unit 721 and a flag indicating as a use target of the vehicle cabin delivery service for lessee user is added to the service login ID of the C2C car sharing service. Accordingly, the C2C car sharing management server 70 can specify whether or not the lessee user is a use target of the vehicle cabin delivery service for lessee user based on the service login ID of the lessee user. Furthermore, for example, when the inquiry including the service login ID of the lessee user of the delivery site is received from the delivery management server 50 by the communication processing unit 721, the C2C car sharing management server 70 can specify the service login ID of the corresponding lessee user of the C2C car sharing site.

The service cooperation registration unit 722 performs information registration for cooperation between the EC server 60 and the C2C car sharing management server 70 relating to use of the vehicle cabin delivery service for lessee user.

For example, the service cooperation registration unit 722 registers (stores) in the storage unit 720 such that a service login ID of the lessee user in the C2C car sharing site which has been registered in the storage unit 720 is linked to a service login ID of the EC site registered by the lessee user via the C2C car sharing service. Specifically, the service cooperation registration unit 722 inquires of the EC server 60 for user confirmation via the communication processing unit 721 based on the service login ID and the password of the C2C site, which have been registered by the lessee user via the C2C car sharing site. Furthermore, the service cooperation registration unit 722 registers (stores) in the storage unit 720, specifically, such that the service login ID of the C2C car sharing site is linked to the service login ID of the EC site registered by the lessee user via the C2C car sharing site when the authentication success is notified from the EC server 60 via the communication processing unit 721. Accordingly, for example, when the inquiry including the service login ID of the lessee user of the delivery site is received from the EC server 60 by the communication processing unit 721, the C2C car sharing management server 70 can specify the service login ID of the corresponding lessee user of the C2C car sharing site.

Furthermore, the information registered for mutual cooperation in each of the delivery management server 50, the EC server 60 and the C2C car sharing management server 70 may be information registered in any one of the servers that is shared by other servers. That is, the service login IDs of the delivery site and the EC site are registered by the lessee user, for example, via the C2C car sharing site, a correspondence between the service login IDs of the delivery site, the EC site and the C2C car sharing site may be shared from the C2C car sharing management server 70 to the delivery management server 50 and the EC server 60. Accordingly, the lessee user does not have to perform information registration for mutual cooperation in each of the sites, thereby improving convenience for the lessee user.

The reservation management unit 723 manages a reservation of use of the vehicle 10A, as described above.

For example, the reservation management unit 723 (an example of the reservation acceptance unit) accepts a reservation of use of the vehicle 10A from the user with rental option stored in the storage unit 720 and within a range of the date and time on which the vehicle 10A is rentable according to the request from a user terminal (an example of the user terminal of the car rental service) of the lessee user at the C2C car sharing site, or the request from a terminal (an example of the user terminal of the car rental service) for accepting a rental reservation which is provided in a business office of a service provider of the C2C car sharing service, which is received by the communication processing unit 721. When the reservation management unit 723 accepts a reservation of use of the vehicle 10A from the lessee user, the reservation management unit 723 updates information on a rental schedule of the vehicle 10A (rental schedule information) stored in the storage unit 720. In this case, the reservation management unit 723 transmits the updated rental schedule information to the center server 30 via the communication processing unit 721, as described above. Accordingly, the center server 30 is capable of updating the latest vehicle use schedule information of the vehicle 10A rented by the C2C car sharing service.

For example, when the authentication key acquisition request is received from the mobile terminal 20Ad of the lessee of the vehicle 10A by the communication processing unit 721, the reservation management unit 723 determines whether or not the authentication key acquisition request is a regular authentication key acquisition request, as described above. When the authentication key acquisition request is a regular authentication key acquisition request, the reservation management unit 723 transmits an authentication key arrangement request to the center server 30 via the communication processing unit 721, as described above.

The vehicle management unit 724 manages the vehicle 10A that is a rental target, as described above.

The processing device 32 of the center server 30 (an example of the key information management device) that assists in an operation of the vehicle cabin delivery service for lessee user includes the communication processing unit 3201, the condition determination unit 3202, the authentication key issuance unit 3203, the location information management unit 3204, the schedule management unit 3205, and the storage unit 3200, as described above. Furthermore, the processing device 32 of the center server 30 includes, for example, a rental reservation information acquisition unit 3208, a rental vehicle notification unit 3209, and a delivery destination vehicle information notification unit 3210 as functional units that are realized by executing one or more programs stored in the ROM or the auxiliary storage device on the CPU.

When the authentication key arrangement request is received from the delivery management server 50 by the communication processing unit 3201, the condition determination unit 3202 determines whether or not the authentication key arrangement request is a regular authentication key arrangement request, as described above.

When the authentication key arrangement request is received from the C2C car sharing management server 70 by the communication processing unit 3201, the condition determination unit 3202 determines whether or not the authentication key arrangement request is a regular authentication key arrangement request, as described above.

When the condition determination unit 3202 determines that the authentication key arrangement request received from the delivery management server 50 is a regular authentication key arrangement request, the authentication key issuance unit 3203 (an example of the key information distribution unit) issues the authentication key corresponding to the regular authentication key arrangement request and distributes the authentication key to the mobile terminal 20Ac of the deliverer, as described above.

When the condition determination unit 3202 determines that the authentication key arrangement request received from the C2C car sharing management server 70 is a regular authentication key arrangement request, the authentication key issuance unit 3203 issues the authentication key corresponding to the regular authentication key arrangement request and distributes the authentication key to the mobile terminal 20Ad of the lessee of the vehicle 10A, as described above.

In response to the inquiry about the current location of the vehicle 10 A, which is received from the delivery management server 50 or the C2C car sharing management server 70 by the communication processing unit 3201, the location information management unit 3204, for example, acquires the location information from the vehicle 10A and provides (transmits) the location information to the delivery management server 50 or the C2C car sharing management server 70 via the communication processing unit 3201, as the described above.

The schedule management unit 3205 updates the vehicle use schedule information stored in the storage unit 3200, for example, based on the rental schedule information received by the communication processing unit 3201.

The rental reservation information acquisition unit 3208 acquires the rental reservation information transmitted from the C2C car sharing management server 70 via the communication processing unit 3201, and stores such information in the storage unit 3200. In this case, the rental reservation information acquisition unit 3208 may store in the storage unit 3200 the rental reservation information which is linked to a lessee user ID of the vehicle 10A corresponding to the rental reservation information and a service login ID of the C2C car sharing site corresponding to the lessee user ID.

When information (for example, information for designating the delivery destination) relating to the delivery request for the ordered product from the lessee user is input through the EC site accessed via the user terminal of the lessee user or through the EC application activated by the user terminal, the rental vehicle notification unit 3209 notifies the lessee user, via the user terminal, of the vehicle 10A specified by the rental reservation information, that is, the vehicle 10A (hereinafter simply referred to as a “rental vehicle”) for which the regular rental reservation has been completed by the lessee user, and which is actually rented out or scheduled to be rented out to the lessee user. For example, the rental vehicle notification unit 3209 displays on a screen of the EC site or the EC application the rental vehicle for which the regular rental reservation has been completed via an application programming interface (API) link, which is embedded in the EC site (specifically, the order input page) displayed on a display device of the user terminal (for example, the display 24 of the mobile terminal 20Ad) or embedded in the EC application window (specifically, the order input window). Specifically, the rental vehicle notification unit 3209 reads, in accordance with calling from the API link embedded in a screen of the EC site or the EC application, the rental reservation information corresponding to the lessee user specified by the input information upon calling from the storage unit 3200. Furthermore, the rental vehicle notification unit 3209 displays information on the rental vehicle specified by the acquired rental reservation information on the screen of the EC site or the EC application via the API link. Accordingly, when the delivery destination is designated by the lessee user, a trunk of the notified rental vehicle may be selected as the delivery destination and the lessee user does not have to input information on the rental vehicle by him/herself. Therefore, the center server 30 can improve convenience for the lessee user upon inputting the information on the delivery request via the EC site or the EC application.

As described above, the vehicle cabin delivery service for regular user in which a package other than the ordered product at the EC site is a target can also be assumed. In this case, the rental vehicle notification unit 3209 may display on a screen of the delivery site or the delivery application via the user terminal of the lessee user the rental vehicle (vehicle 10A) for which the regular rental reservation has been completed with the lessee user as a rental target. Furthermore, the rental vehicle notification unit 3209 may display on a display of the input terminal in the business office of the delivery company visited by the lessee user the rental vehicle (vehicle 10A) for which the regular rental reservation has been completed with the lessee user as a rental target.

When a trunk of the rental vehicle (vehicle 10A) notified by the rental vehicle notification unit 3209 is designated (confirmed) as the delivery destination in accordance with a predetermined manipulation on the user terminal of the lessee user, the delivery destination vehicle information notification unit 3210 transmits information (hereinafter simply referred to as “delivery destination vehicle information”) on the vehicle 10A (hereinafter simply referred to as a “delivery destination vehicle”) corresponding to the confirmed delivery destination to the EC server 60.

The rental vehicle may be displayed on the user terminal of the lessee user from the center server 30 via the EC server 60, instead of being displayed on the user terminal of the lessee user directly from the center server 30 via the API link embedded in the EC site or the like. In this case, the rental vehicle rented out or scheduled to be rented out to the lessee user is notified to the EC server 60 before confirming the delivery destination vehicle, thus the delivery destination vehicle information notification unit 3210 is omitted.

A part of all of various functions of the center server 30 associated with the vehicle cabin delivery service for lessee user, that is, functions of the condition determination unit 3202, the authentication key issuance unit 3203, the location information management unit 3204, the schedule management unit 3205, the rental reservation information acquisition unit 3208, the rental vehicle notification unit 3209, and the delivery destination vehicle information notification unit 3210 may be transferred to the delivery management server 50 corresponding to the actual delivery work, the EC server 60 corresponding to the EC site in which the delivery request is established by the lessee user, or the C2C car sharing management server 70 that assist in rental of the vehicle 10A.

For example, functions of the rental reservation information acquisition unit 3208 and the rental vehicle notification unit 3209 may be transferred to the EC server 60.

For example, when a package other than the product ordered at the EC site is a delivery target in the vehicle cabin delivery service for lessee user, functions of the rental reservation information acquisition unit 3208 and the rental vehicle notification unit 3209 may be transferred to the delivery management server 50 (an example of the information processing device).

For example, a part or all of functions of the condition determination unit 3202, the authentication key issuance unit 3203, the location information management unit 3204, the schedule management unit 3205, the rental reservation information acquisition unit 3208, the rental vehicle notification unit 3209, and the delivery destination vehicle information notification unit 3210 may be transferred to the C2C car sharing management server 70 (an example of the key information management device). When, for example, the trunk of the rental vehicle (vehicle 10B) rented by the B2C car sharing service is designated as the delivery destination in the vehicle cabin delivery service for lessee user, a part or all of those functions may be transferred to the B2C car sharing management server 80 (an example of the key information management device).

The processing device 23 of the mobile terminal 20Ac of a deliverer includes the communication processing unit 2301, the communication processing unit 2302, the authentication key acquisition unit 2303, the authentication request unit 2304, and the locking and unlocking request unit 2305, as described above.

The authentication key acquisition unit 2303 transmits the authentication key acquisition request to the delivery management server 50 via the communication processing unit 2302 according to a predetermined manipulation by a deliverer, as described above. The authentication key acquisition unit 2303 acquires the authentication key from the center server 30 via the communication processing unit 2302. Therefore, the mobile terminal 20Ac can lock and unlock the trunk lid of the vehicle 10A based on the functions of the communication processing unit 2301, the authentication request unit 2304, and the locking and unlocking request unit 2305. Therefore, the deliverer can deliver the requested package to the trunk of the vehicle 10A and return after locking the trunk of the vehicle 10A.

The processing device 23 of the mobile terminal 20Ad of the lessee of the vehicle 10A (delivery destination) includes the communication processing unit 2301, the communication processing unit 2302, the authentication key acquisition unit 2303, the authentication request unit 2304, the locking and unlocking request unit 2305, and the storage unit 2300, as described above.

The authentication key acquisition unit 2303 transmits an authentication key acquisition request to the C2C car sharing management server 70 via the communication processing unit 2302 according to a predetermined manipulation by the lessee, as described above. The authentication key acquisition unit 2303 acquires an authentication key from the center server 30 according to the authentication key arrangement request from the C2C car sharing management server 70 via the communication processing unit 2301. Specifically, the authentication key acquisition unit 2303 acquires the authentication key having authority concerning a function to lock/unlock or activate the vehicle 10A in accordance with the rental option of the delivery destination vehicle (vehicle 10A) and the rented part of the vehicle cabin, as described above. Accordingly, the mobile terminal 20Ad can lock and unlock the trunk lid of the vehicle 10A based on the functions of the communication processing unit 2301, the authentication request unit 2304, and the locking and unlocking request unit 2305. Therefore, the lessee user, who has designated the trunk of the vehicle 10A rented by the C2C car sharing as the delivery destination of a package ordered at the EC site or the like, can unlock the trunk of the vehicle 10A using the mobile terminal 20Ad with the acquired authentication key to pick up the package delivered to the trunk.

Details of Operation of Authentication Key Management System Relating to Vehicle Cabin Delivery Service for Lessee User

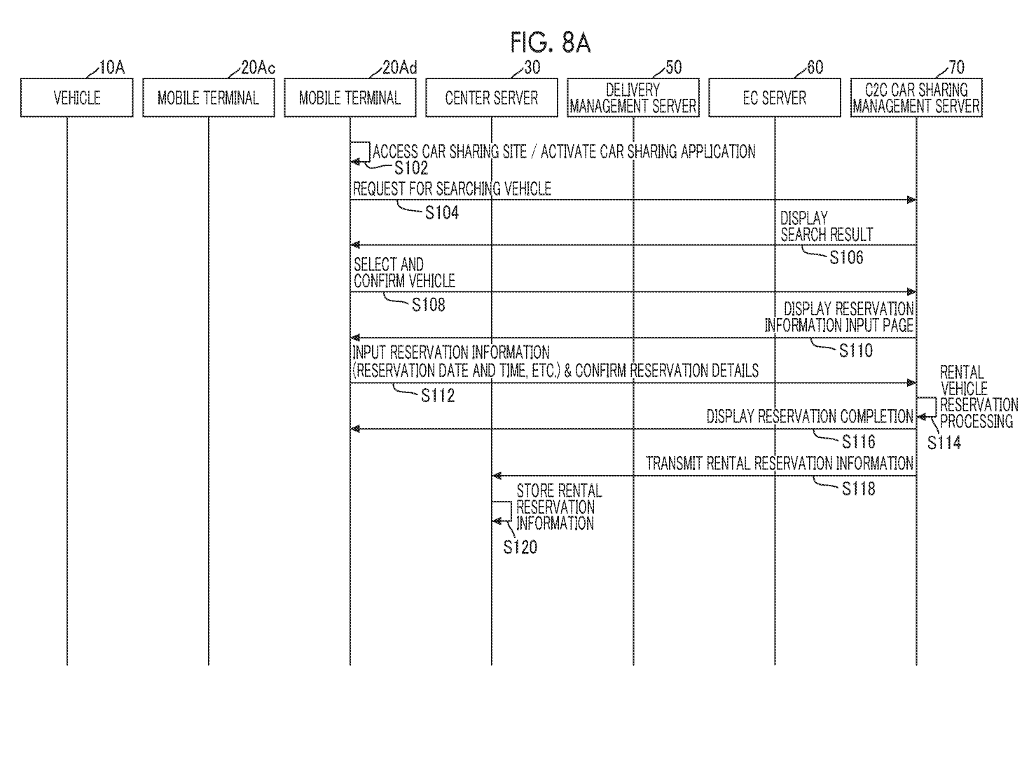

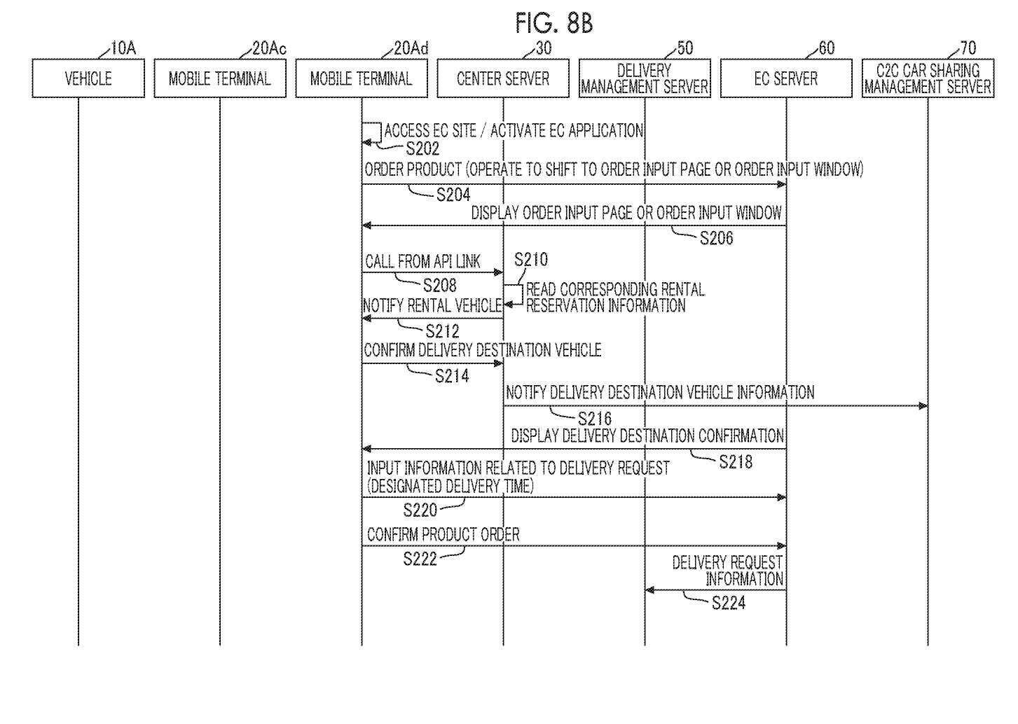

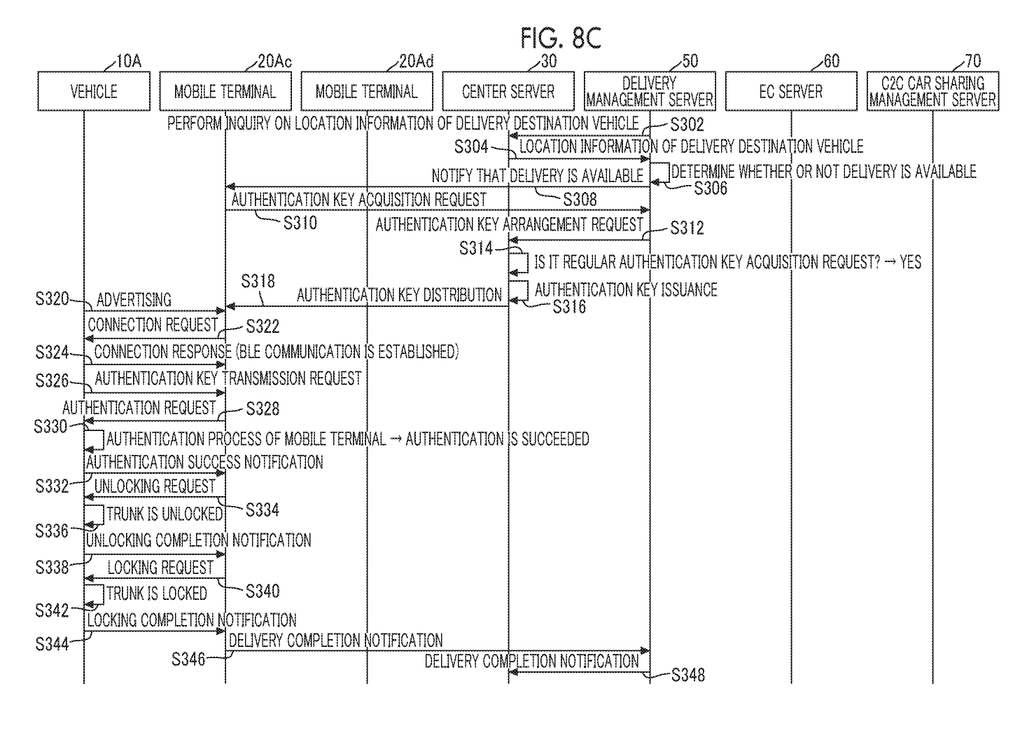

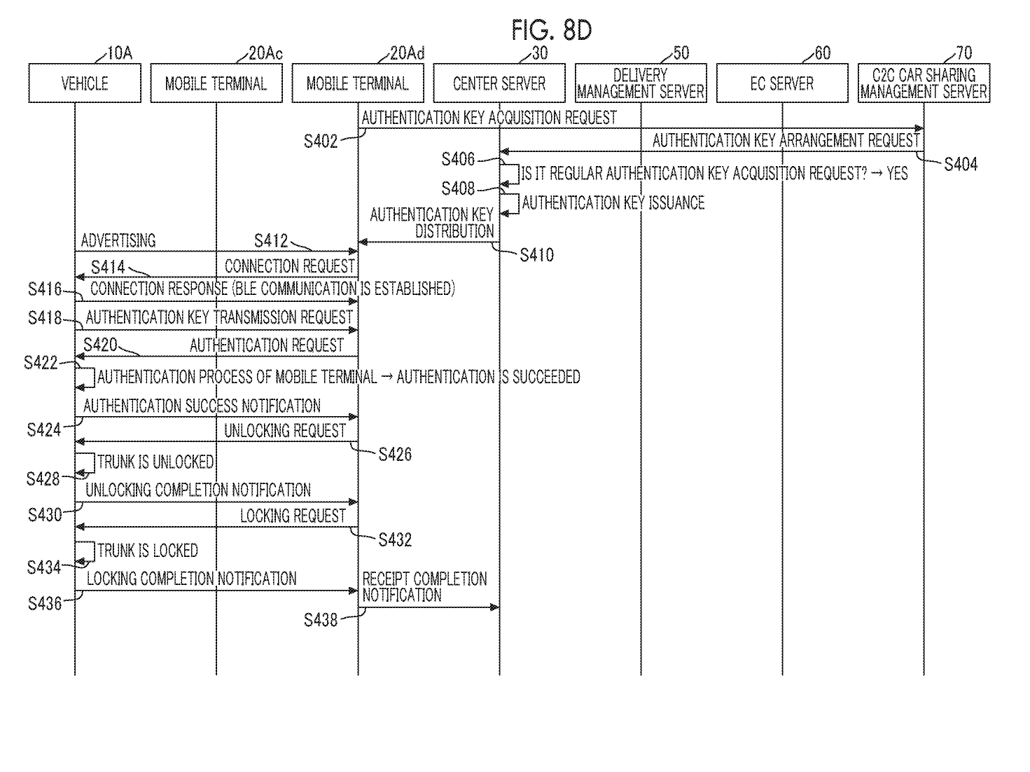

Details of an operation of the authentication key management system 1 relating to the vehicle cabin delivery service for lessee user will be described with reference to FIG. 8A to 8D.

FIG. 8A to 8D are sequence diagrams illustrating an example of an operation of the authentication key management system 1 relating to the vehicle cabin delivery service for lessee user. Specifically, FIG. 8A is a sequence diagram illustrating an example of an operation of the authentication key management system 1 relating to a rental reservation process of the vehicle 10A by the lessee user in the C2C car sharing site or the like. FIG. 8B is a sequence diagram illustrating an example of an operation of the authentication key management system 1 relating to a process from the product order by the lessee in the EC site or the like to the delivery request completion in which the trunk of the vehicle 10A rented with a trunk sharing rental option is designated as the delivery destination. FIG. 8C is a sequence diagram illustrating an example of an operation of the authentication key management system 1 relating to a delivery process for delivering a package to the trunk of the vehicle 10A rented with the trunk sharing rental option. FIG. 8D is a sequence diagram illustrating an example of an operation of the authentication key management system 1 relating to a receipt process of receiving the package delivered to the trunk of the vehicle 10A by the lessee user of the vehicle 10A rented with the trunk sharing rental option. FIG. 8D is a sequence diagram illustrating an example of an operation of the authentication key management system 1 relating to a process when a rental period of the vehicle 10A rented with the trunk sharing rental option is expired.

Hereinafter, in the embodiment, description will be given on the premise that the lessee user carries out a rental reservation of the vehicle 10A by the C2C car sharing service using the mobile terminal 20Ad. Furthermore, in the embodiment, description will be given on the premise that the lessee user orders a product at the EC site using the mobile terminal 20Ad.

Process for Rental Reservation of Vehicle

In step S102, the processing device 23 of the mobile terminal 20Ad accesses the C2C car sharing site via a predetermined browser in accordance with a predetermined manipulation of the lessee user, or activates a C2C car sharing application in cooperation with the C2C car sharing site.

In step S104, the processing device 23 of the mobile terminal 20Ad transmits to the C2C car sharing management server 70 a search request for the vehicle 10A satisfying conditions (for example, date and time on which the vehicle is rentable or available rental location) input via a screen (hereinafter referred to as a “webpage of the C2C car sharing site” for convenience) of a predetermined webpage of the C2C car sharing site or a screen of the C2C car sharing site, in accordance with a predetermined manipulation of the lessee user.

In step S106, the reservation management unit 723 of the C2C car sharing management server 70 searches for the vehicle 10A satisfying the conditions in accordance with the search request. The reservation management unit 723 transmits search results to the mobile terminal 20Ad via the communication processing unit 721 to display the search results on the webpage of the C2C car sharing site, which is displayed on the display 24 of the mobile terminal 20Ad.

In step S108, the processing device 23 of the mobile terminal 20Ad selects the vehicle 10A out of the vehicles 10A which are displayed on the webpage of the C2C car sharing site as the search results in accordance with a predetermined manipulation of the lessee user, and confirms such a vehicle as the vehicle 10A of a rental reservation target.

In step S110, the reservation management unit 723 of the C2C car sharing management server 70 displays, for example, the webpage (hereinafter simply referred to as a “reservation information input page”) for inputting various information on the rental reservation of the vehicle 10A confirmed as the rental reservation target on the display 24 of the mobile terminal 20Ad via the communication processing unit 721.

In step S112, the processing device 23 of the mobile terminal 20Ad inputs, for example, the reservation information including, for example, date and time of the rental reservation (date and time of use start and date and time of use end) on the reservation information input page of the C2C car sharing site in response to the manipulation by the lessee user, thereby allowing the user to confirm the reservation details.

In step S114, the reservation management unit 723 of the C2C car sharing management server 70 performs rental reservation processing of the vehicle 10A (rental vehicle) based on the confirmed details of the reservation (the vehicle 10A as the rental target, rental date and time, rental location, rental charge, etc.) which are received via the communication processing unit 721.

In step S116, the reservation management unit 723 of the C2C car sharing management server 70 displays that the rental reservation is established on the display 24 of the mobile terminal 20Ad via the communication processing unit 721 after the rental reservation is completed.

In step S118, the reservation management unit 723 of the C2C car sharing management server 70 transmits rental reservation information corresponding to the rental reservation to the center server 30 via the communication processing unit 721 in response to the rental reservation completion of the vehicle 10A for the lessee user.

In step S120, the rental reservation information acquisition unit 3208 of the center server 30 stores the rental reservation information acquired by the communication processing unit 3201 in the storage unit 3200, as described above.

Process from Product Order to Delivery Request Completion

In step S202, the mobile terminal 20Ad accesses the EC site via a predetermined browser, or activates the EC application in cooperation with the EC site, in response to a predetermined manipulation of the lessee user.

In step S204, the mobile terminal 20Ad receives an operation to shift to the order input page or the order input window for ordering a product selected by the lessee user (for example, a product placed in a virtual cart on the EC site), and transmits such an operation to the EC server 60.

In step S206, the web resource transmission unit 622 of the EC server 60 shifts a page of the browser of the mobile terminal 20Ad to the order input page, or shifts a window of the EC application to the order input window, in response to the operation on the mobile terminal 20Ad.

In step S208, the mobile terminal 20Ad calls functions of the center server 30 from the API link embedded in input portions of the various information relating to the delivery request on the order input page or the order input screen, corresponding to displaying such input portions.

In step S210, the rental vehicle notification unit 3209 of the center server 30 reads the rental reservation information corresponding to the lessee user from the storage unit 3200 in response to call using the API link of the mobile terminal 20Ad.

In step S212, the rental vehicle notification unit 3209 of the center server 30 notifies of the rental vehicle specified by the rental reservation information via the API link embedded in the order input page or the order input window, which is displayed on the display 24 of the mobile terminal 20Ad.

In step S214, the mobile terminal 20Ad selects (designates) a trunk of the rental vehicle (any one of the rental vehicles if there are several candidates) as the delivery destination of the product, which is displayed on the order input page or the order input window on the display 24, in response to a manipulation of the lessee user. The mobile terminal 20Ad confirms the vehicle 10A corresponding to the selected delivery destination as the delivery destination in response to a manipulation of the lessee user, and notifies the center server 30 of the confirmed vehicle 10A.

In step S216, the delivery destination vehicle information notification unit 3210 of the center server 30 transmits (notifies) information relating to the vehicle 10A (delivery destination vehicle) notified from the mobile terminal 20Ad to the C2C car sharing management server 70 via the communication processing unit 3201.

In step S218, the web resource transmission unit 622 of the EC server 60 displays that the trunk of the delivery destination vehicle (vehicle 10A) notified from the center server 30 is confirmed as the delivery destination, on the order input page of the EC site or the order input window of the EC application on the mobile terminal 20Ad (display 24).

In step S220, the mobile terminal 20Ad inputs information relating to the delivery request (for example, designated delivery date and time) on the order input page of the EC site or the order input window of the EC application in response to a manipulation of the lessee user.

In step S222, the mobile terminal 20Ad confirms the product order at the EC site or the EC application in response to a manipulation of the lessee user.

In step S224, the order reception processing unit 624 of the EC server 60 transmits delivery request information relating to the product to the delivery management server 50 via the communication processing unit 621 in response to confirmation of the product order through the EC site or the EC application. Accordingly, the delivery management server 50 can receive the delivery request in which the trunk of the vehicle 10A rented out to the lessee user is designated as the delivery destination.

Process for Delivering Package to Rented Vehicle 10A

In step S302, the delivery management unit 524 of the delivery management server 50 inquiries for location information of the vehicle 10A rented out with the trunk sharing rental option to the lessee user, which is the delivery destination vehicle, via the communication processing unit 521.

In step S304, the location information management unit 3204 of the center server 30 acquires the location information of the delivery destination vehicle and returns the location information to the delivery management server 50, by the communication processing unit 3201, in response to the inquiry for the location information of the delivery destination vehicle from the delivery management server 50 via the communication processing unit 3201.

In step S306, the delivery management unit 524 of the delivery management server 50 determines whether the delivery is available or not, based on the location information of the delivery destination vehicle received from the center server by 30 the communication processing unit 521.

In step S308, the delivery management unit 524 of the delivery management server 50 transmits a delivery available notification to the mobile terminal 20Ac of the deliverer via the communication processing unit 521 when determining that the delivery is available. Accordingly, the deliverer is able to visually recognize details of the delivery available notification displayed on the display 24 of the mobile terminal 20Ac in a format of push notifications, and figure out that the target package can be delivered, in response to receipt of the delivery available notification.

In step S310, the mobile terminal 20Ac transmits the authentication key acquisition request to the delivery management server 50 in response to a predetermined manipulation performed by the deliverer who has confirmed that the delivery is available.

Furthermore, the deliverer may perform a manipulation for transmitting an authentication key acquisition request from the mobile terminal 20Ac to the delivery management server 50 at any timing (for example, immediately after the confirmation, when the delivery order of the target package is up next, immediately before the deliverer approaches the vehicle 10A, etc.) after confirming that the delivery is available.

In step S312, the delivery management unit 524 of the delivery management server 50 transmits an authentication key arrangement request to the center server 30 after the regular authentication key acquisition request from the mobile terminal 20Ac of the deliverer by the communication processing unit 521.

In step S314, when the authentication key arrangement request is received from the delivery management server 50 by the communication processing unit 3201, the condition determination unit 3202 of the center server 30 determines whether or not such an authentication key arrangement request is a regular authentication key arrangement request.

In step S316, the authentication key issuance unit 3203 of the center server 30 issues an authentication key corresponding to the authentication key arrangement request when the condition determination unit 3202 determines that such an authentication key arrangement request is a regular authentication key arrangement request.

In step S318, the authentication key issuance unit 3203 of the center server 30 transmits the issued authentication key to the mobile terminal 20Ac of the deliverer via the communication processing unit 3201.

In step S320, the key unit 12 of the delivery destination vehicle (vehicle 10A) periodically transmits an advertising packet toward the vicinity of the vehicle 10A.

In step S322, when the deliverer approaches within a communication range of the BLE communication of the key unit 12 of the delivery destination vehicle (vehicle 10A), the communication processing unit 2301 of the mobile terminal 20Ac receives the advertising packet. The communication processing unit 2301 of the mobile terminal 20Ac transmits a connection request to the key unit 12 of the vehicle 10A by the BLE communication in response to receipt of the advertising packet.

In step S324, the key unit 12 of the vehicle 10A establishes the BLE connection in response to the connection request, and transmits a connection response that communicable state is established by the BLE communication to the mobile terminal 20Ac.

In step S326, the key unit 12 of the vehicle 10A transmits a transmission request of the authentication key to the mobile terminal 20Ac after establishing of the communicable connection state with the mobile terminal 20Ac by the BLE communication.

In step S328, the authentication request unit 2304 of the mobile terminal 20Ac transmits an authentication request including the authentication key when the transmission request of the authentication key is received from the key unit 12 of the vehicle 10A via the communication processing unit 2301.

In step S330, when the authentication request including the authentication key is received from the mobile terminal 20Ac, the key unit 12 of the vehicle 10A performs an authentication process of the mobile terminal 20Ac, a sender.

In step S332, the key unit 12 of the vehicle 10A transmits an authentication success notification to the mobile terminal 20Ac when the authentication of the mobile terminal 20Ac is succeeded.

In step S334, the locking and unlocking request unit 2305 of the mobile terminal 20Ac transmits an unlocking request to the key unit 12 of the vehicle 10A in response to a predetermined manipulation by the deliverer.

In step S336, the key unit 12 of the vehicle 10A transmits an unlocking signal to the locking, unlocking and activation device 11 after receiving the unlocking request from the authenticated mobile terminal 20Ac, in order to unlock a door accessing the trunk of the vehicle 10A.

In step S338, the key unit 12 of the vehicle 10A receives an unlocking notification that the door accessing the trunk of the vehicle 10A is unlocked from the locking, unlocking and activation device 11, and then transmits an unlocking completion notification that the door accessing the trunk of the vehicle 10A is unlocked to the mobile terminal 20Ac.

In step S340, the deliverer delivers (places) the package to the trunk of the vehicle 10A, and then performs a predetermined manipulation on the mobile terminal 20Ac. The locking and unlocking request unit 2305 of the mobile terminal 20Ac transmits a locking request to the key unit 12 of the vehicle 10A in response to such a predetermined manipulation.

In step S342, the key unit 12 of the vehicle 10A transmits a locking signal to the locking, unlocking and activation device 11 after receiving the locking request from the authenticated mobile terminal 20Ac, in order to lock the door accessing the trunk of the vehicle 10A.

In step S344, the key unit 12 of the vehicle 10A receives a locking notification that the door accessing the trunk of the vehicle 10A is locked from the locking, unlocking and activation device 11, and then transmits a locking completion notification that the door accessing the trunk of the vehicle 10A is locked to the mobile terminal 20Ac.

In step S346, the mobile terminal 20Ac transmits a delivery completion notification to the delivery management server 50 in response to a predetermined manipulation by the deliverer.

In step S348, the delivery management unit 524 of the delivery management server 50 transmits to the center server 30 the delivery completion notification that the delivery is completed for the target package with the delivery destination designated as the trunk of the vehicle 10A rented out with the trunk sharing rental option, via the communication processing unit 521, after receiving the delivery completion notification from the mobile terminal 20Ac of the deliverer by the communication processing unit 521.

Process for Receiving Package by Lessee of Rented Vehicle 10A

In step S402, the authentication key acquisition unit 2303 of the mobile terminal 20Ad of the lessee transmits an authentication key acquisition request to the C2C car sharing management server 70 via the communication processing unit 2302 in response to a predetermined manipulation by the lessee.

In step S404, when the regular authentication key acquisition request is received from the mobile terminal 20Ad of the lessee by the communication processing unit 721, the reservation management unit 723 of the C2C car sharing management server 70 transmits an authentication key arrangement request corresponding to the authentication key acquisition request to the center server 30 via the communication processing unit 721.

In step S406, when the authentication key arrangement request is received from the C2C car sharing management server 70 by the communication processing unit 3201, the condition determination unit 3202 of the center server 30 determines whether or not such an authentication key arrangement request is a regular authentication key arrangement request.

In step S408, the authentication key issuance unit 3203 of the center server 30 issues an authentication key corresponding to the authentication key arrangement request when the condition determination unit 3202 determines that such an authentication key arrangement request is a regular authentication key arrangement request.

In step S410, the authentication key issuance unit 3203 of the center server 30 transmits the issued authentication key to the mobile terminal 20Ad of the lessee of the vehicle 10A via the communication processing unit 3201.

Since processes of steps S412 to S436 are the same as the processes of steps S320 to S344 in FIG. 8C except for that a target communicable with the vehicle 10A (key unit 12) by the BLE communication is replaced with the mobile terminal 20Ad of the lessee of the vehicle 10A from the mobile terminal 20Ac of the deliverer, description thereof will be omitted.

In step S438, the mobile terminal 20Ad of the lessee of the vehicle 10A determines that the package is picked up by the lessee when receiving the unlocking completion notification and the locking completion notification from the vehicle 10A (key unit 12), and transmits a receipt completion notification to the center server 30. Accordingly, the center server 30 can figure out that the delivered product has been received.

The receipt completion notification may be transmitted from the DCM 14 of the vehicle 10A to the center server 30 after receiving the unlocking notification and the locking notification from the locking, unlocking and activation device 11 by the key unit 12 of the vehicle 10A.

Operation

In the embodiment, the order reception processing unit 624 or the delivery reception unit 523 chooses as a delivery destination of a package a vehicle cabin including a trunk (vehicle cabin) of a rental vehicle (vehicle 10A or vehicle 10B) scheduled to be rented to, or having been rented out to a user of a delivery service by a predetermined car rental service (for example, C2C car sharing service, B2C car sharing service or other car rental services) in response to a request from a user terminal carried by the user of the vehicle cabin delivery service for lessee user. The authentication key issuance unit 3203 distributes key information (authentication key) used for unlocking a door accessing the vehicle cabin of the rental vehicle to a delivery company (for example, mobile terminal 20Ac of deliverer) within a rental period of the rental vehicle corresponding to the delivery destination chosen by the order reception processing unit 624 or the delivery reception unit 523.

Accordingly, the authentication key management system 1 is capable of designating the vehicle cabin of the rental vehicle rented by a car sharing service or a car rental service as the delivery destination of the package, and to allow the delivery company to acquire the key information for unlocking the door accessing the vehicle cabin of the rental vehicle. Therefore, a deliverer of the delivery company can unlock the door of the rental vehicle designated as the delivery destination using the acquired key information to deliver the package to the vehicle cabin of the rental vehicle. That is, the authentication key management system 1 is able to implement a mechanism of the vehicle cabin delivery service in which the vehicle cabin of the rental vehicle rented by the car sharing service or the like can be designated as the delivery destination of the package. The user is able to receive the vehicle cabin delivery service using the rental vehicle rented by the car sharing service or the like even when a vehicle owned by him/herself or his/her close relatives cannot be accessed. Consequently, the authentication key management system 1 is capable of allowing the user who cannot use a vehicle owned by him/herself or his/her close relatives to use delivery service in which the vehicle cabin of the rental vehicle can be designated as the delivery destination of the package.

In the embodiment, the authentication key is directly distributed from the center server 30 to the mobile terminal 20Ac of the deliverer, but may be distributed from the center server 30 to the delivery management server 50 to be provided to the mobile terminal 20Ac of the deliverer via the delivery management server 50.

In the embodiment, the rental reservation information acquisition unit 3208 acquires rental reservation information associated with rental reservation of the vehicle 10 by the user from a predetermined external device (for example, C2C car sharing management server 70 or B2C car sharing management server 80) relating to the car rental service when the delivery destination of the package is designated by the user terminal of the vehicle cabin delivery service for lessee user. The rental vehicle notification unit 3209 notifies the user of the rental vehicle specified by the rental reservation information via the user terminal of the vehicle cabin delivery service for lessee user.

Accordingly, the authentication key management system 1 is capable of notifying the user of the reserved rental vehicle on the user terminal by which a delivery request is made without receiving an instruction from the user. Therefore, the user does not need to do extra operations including separate confirmation of information relating to the rental vehicle upon transmitting the delivery request from the user terminal, thereby improving convenience and workability when the delivery request is made. The user also does not need to do extra operations including separate confirmation of whether or not the rental reservation of the rental vehicle is properly completed as a premise of the delivery request, thereby improving convenience and workability when the delivery request is made from this viewpoint. Consequently, the authentication key management system 1 is capable of improving convenience and workability upon making the delivery request for the vehicle cabin delivery service in which the vehicle cabin of the rental vehicle rented by the car sharing service or the like can be designated as the delivery destination of the package by the user via the user terminal.

In the embodiment, the rental vehicle notification unit 3209 displays the rental vehicle identified by the rental reservation information on a display device of the user terminal.

Accordingly, the authentication key management system 1 is capable of notifying the user of the reserved rental vehicle by display the reserved rental vehicle on the display device (for example, a display of a smartphone, etc.) of the user terminal by which the delivery request is made.

In the embodiment, the order reception processing unit 624 or the delivery reception unit 523 chooses the vehicle cabin of the rental vehicle as the delivery destination in a case where the rental vehicle displayed on the display device is selected and the vehicle cabin of the rental vehicle is designated as the delivery destination in response to a predetermined manipulation on the user terminal.

Accordingly, the authentication key management system 1 is capable of, specifically, choosing the vehicle cabin of the reserved rental vehicle as the delivery destination of the package by causing the user to directly select the reserved rental vehicle displayed on the display device of the user terminal by which the delivery request is made.

In the embodiment, the user terminal of the vehicle cabin delivery service by which the delivery request is carried out is a terminal (for example, mobile terminal 20Ad, etc.) directly operated by the user, or a terminal (for example, input terminal for receiving the delivery request in a business office of the delivery company) to which an input content corresponding to a request from the user is input by the delivery company providing the vehicle cabin delivery service.

Accordingly, the authentication key management system 1 is capable of implementing the vehicle cabin delivery service using the rental vehicle rented by the car sharing service or the like based on a request from the terminal directly operated by the user, for example, a smartphone carried by the user. Furthermore, the authentication key management system 1 is capable of implementing the vehicle cabin delivery service using the rental vehicle rented by the car sharing service or the like based on a request from a delivery request terminal provided at a business office of the delivery company or the like.

In the embodiment, the reservation management unit 723 or the reservation management unit 822 accepts a rental reservation of the rental vehicle (vehicle 10A or vehicle 10B). Specifically, the reservation management unit 723 or the reservation management unit 822 accepts a reservation to rent a trunk portion of the rental vehicle to the user in response to a request from a user terminal of the car rental service (that is, C2C car sharing service or B2C car sharing service), and accept a reservation from another user of the car rental service to rent the rental vehicle for using the vehicle cabin other than the trunk portion (that is, passenger compartment) within a rental period corresponding to the reservation.

Accordingly, the authentication key management system 1 is capable of separately renting the trunk portion used as the delivery destination in the vehicle cabin delivery service and the vehicle cabin (that is, passenger compartment) other than the trunk portion, which is used as an accommodation place or used for driving the rental vehicle, for the rental vehicle rented by the car sharing service or the like. Therefore, the authentication key management system 1 is capable of efficiently operating the rental service of the rental vehicle such as the car sharing service.

In the embodiment, the order reception processing unit 624 of the EC server 60 or the delivery reception unit 523 of the delivery management server 50 chooses as a delivery destination of a package a vehicle cabin including a trunk of a rental vehicle (vehicle 10A or vehicle 10B) scheduled to be rented out, or having been rented out to a user of a delivery service by a predetermined car rental service (for example, C2C car sharing service, B2C car sharing service or other car rental services) in response to a request from a user terminal carried by the user of the vehicle cabin delivery service for lessee user.

Accordingly, the delivery management server 50 or the EC server 60 is capable of allowing the delivery company to offer the vehicle cabin delivery service to the user, in which the package is delivered to the vehicle cabin of the rental vehicle rented by the car sharing service, the car rental service, or the like. Therefore, the user is able to use the vehicle cabin delivery service using the rental vehicle rented by the car sharing service or the like even when the user cannot use a vehicle owned by him/herself or his/her close relatives. Accordingly, the delivery management server 50 or the EC server 60 is capable of enabling the user who cannot use the vehicle owned by him/herself or his/her close relatives to use the delivery service (vehicle cabin delivery service) in which the vehicle cabin of the vehicle can be designated as the delivery destination of the package.

In the embodiment, the authentication key issuance unit 3203 of the center server 30 distributes authentication key used for unlocking a door accessing the vehicle cabin of the rental vehicle to a delivery company providing the vehicle cabin delivery service within a rental period of the rental vehicle when a vehicle cabin of a rental vehicle scheduled to be rented out, or having been rented out to a user of a delivery service by a predetermined car rental service (for example, C2C car sharing service, B2C car sharing service or other car rental services) is chosen as a delivery destination of a in response to a request from the user in the vehicle cabin delivery service.

Accordingly, the center server 30 is capable of allowing the delivery company providing the vehicle cabin delivery service to implement that the package is delivered to the vehicle cabin of the rental vehicle rented by the car sharing service or the like. Therefore, the user is able to receive the vehicle cabin delivery service using the rental vehicle rented by the car sharing service or the like even when a vehicle owned by him/herself or his/her close relatives cannot be accessed. Consequently, the center server 30 is capable of allowing the user who cannot use a vehicle owned by him/herself or his/her close relatives to use delivery service (vehicle cabin delivery service) in which the vehicle cabin of the rental vehicle can be designated as the delivery destination of the package.

The embodiments for carrying out the present disclosure have been described in detail above, but the present disclosure is not limited to the specific embodiments as described above, and various modifications and changes can be performed without departing from the gist of the present disclosure described in the claims.

For example, in the embodiment described above, the mobile terminal 20 transmits the authentication request including the authentication key to the key unit 12, the key unit 12 performs exchange of signals with the locking, unlocking and activation device 11 according to an authentication result based on the authentication key, and locking and unlocking of the door of the vehicle 10A and activation of the vehicle 10A are realized by the locking, unlocking and activation device 11, however, implement of the present disclosure is not limited thereto.

Specifically, a configuration in which the function of the key unit 12 is transferred to the mobile terminal 20, and the mobile terminal 20 performs exchange of signals based on the above-described key information (internal key information) with the vehicle 10 (the locking, unlocking and activation device 11) using the LF radio waves and the RF radio waves such that the locking and unlocking of the doors of the vehicle 10A and the activation of the vehicle 10A by the locking, unlocking and activation device 11 are realized may be adopted. In this case, the “authentication key” of the embodiment described above may be read as the “key information”. That is, the center server 30 may issue the key information instead of the authentication key and distribute the key information to the mobile terminal 20 in the same method as in the authentication key in the above-described embodiment. Accordingly, the same operation and effects as those of the above-described embodiment can be obtained.

The functions of the key unit 12 may be integrated with the locking, unlocking and activation device 11, and a configuration regarding communication between the locking, unlocking and activation device 11 and the key unit 12 and authentication related to the communication (the LF radio wave transmitter 111, the RF radio wave receiver 112, the collating ECU 113, the LF radio wave receiver 121, and the RF radio wave transmitter 122) may be omitted. In this case, when the authentication of the mobile terminal 20 based on the authentication key has been successful, the key ECU 124 may directly output an unlocking command or a locking command and an activation command to each of the body ECU 114 and the engine ECU 116 instead of the collating ECU 113, and perform locking and unlocking the doors of the vehicle 10 and activation of the vehicle 10. Accordingly, the same operation and effects as those of the above-described embodiment can be obtained.

What is claimed is:

1. An information processing system comprising circuitry configured to:
choose, in response to a request from a user terminal of a delivery service, a vehicle cabin including a trunk of a rental vehicle scheduled to be rented out, or having been rented out to a user of the delivery service by a car rental service, as a delivery destination of a package; and
distribute key information to a delivery company providing the delivery service, the key information being used for unlocking a door accessing the vehicle cabin of the rental vehicle within a rental period of the rental vehicle corresponding to the chosen delivery destination.

2. The information processing system according to claim 1, wherein
the circuitry is configured to
acquire rental reservation information associated with rental reservation of a vehicle by the user from a predetermined external device relating to the car rental service, and
notify the user of the rental vehicle specified by the rental reservation information via the user terminal in a case where the delivery destination of the package is designated by the user terminal.

3. The information processing system according to claim 2, wherein
the circuitry is configured to display the rental vehicle specified by the rental reservation information on a display device of the user terminal.

4. The information processing system according to claim 3, wherein
the circuitry is configured to choose the vehicle cabin of the rental vehicle as the delivery destination of the package in a case where the rental vehicle displayed on the display device is selected and the vehicle cabin of the rental vehicle is designated as the delivery destination in response to a predetermined manipulation on the user terminal.

5. The information processing system according to claim 1, wherein
the circuitry is configured to recognize a terminal directly operated by the user or a terminal to which an input content corresponding to the request from the user is input by the delivery company providing the delivery service, as the user terminal of the delivery service.

6. The information processing system according to claim 1, wherein
the circuitry is configured to
accept a first reservation to rent a trunk portion of the rental vehicle as an accommodation place to the user in response to a request from a user terminal of the car rental service, and
accept a second reservation from another user of the car rental service to rent the rental vehicle for using the vehicle cabin other than the trunk portion within a rental period corresponding to the first reservation.

7. A key information management device comprising
circuitry configured to distribute key information to a delivery company providing a delivery service in a case where a vehicle cabin of a rental vehicle is chosen as a delivery destination of a package in response to a request from a user of the delivery service, the rental vehicle being a vehicle scheduled to be rented out, or having been rented out to the user of the delivery service by a car rental service, the key information being used for unlocking a door accessing the vehicle cabin of the rental vehicle within a rental period of the rental vehicle.

8. A key information management method comprising
distributing key information to a delivery company providing a delivery service in a case where a vehicle cabin of a rental vehicle is chosen as a delivery destination of a package in response to a request from a user, the rental vehicle being a vehicle scheduled to be rented out, or having been rented out to the user of the delivery service by a car rental service, the key information being used for unlocking a door accessing the vehicle cabin of the rental vehicle within a rental period of the rental vehicle.

9. A non-transitory storage medium storing a program causing a key information management device to execute the key information management method according to claim 8 when the program is executed by at least one processing device of the key information management device.
